(19) United States
(12) Patent Application Publication
(10) Pub. No.: US 2018/0270121 A1
(43) Pub. Date: Sep. 20, 2018

(54) Information processing architecture for network edge-based optimization problems

(71) Applicant: Stanley George Stringfellow, San Diego, CA (US)

(72) Inventor: Stanley George Stringfellow, San Diego, CA (US)

(21) Appl. No.: 15/463,019

(22) Filed: Mar. 20, 2017

(51) Int. Cl. H04L 12/24; G06Q 10/04; H04L 29/08; H04W 24/02; H04W 8/02

(52) U.S. Cl. CPC H04L 41/142; H04L 41/0816; H04L 41/0893; H04L 67/12; H04L 67/10; H04W 24/02; H04W 8/02; G06Q 10/047

(57) ABSTRACT

The present invention relates generally to an information processing architecture for network edge-based systems which solve optimization problems by using: 1) subproblem solvers for decomposed mathematical programs, which operate on network edge nodes; and 2) reduced master problem solvers for decomposed mathematical programs, which operate on network edge nodes and/or network core nodes; and 3) dynamic reconfiguration components which assign decomposed mathematical programs to the solvers, and assign the network fog nodes to functional groups within which the solvers on the network fog nodes collectively solve the decomposed mathematical programs. Further, the present invention may optionally solve the optimization problems by using: 1) decomposed mathematical program information schemes which improve the performance of the solvers, and 2) subproblem roaming, which extends the functionality of the dynamic reconfiguration components, and 3) inward facing optimization which automatically enhances the performance of the dynamic reconfiguration components.

### BACKGROUND OF THE INVENTION

### (1) Field of the Invention

The present invention relates generally to an information processing architecture for network edge-based optimization problems.

### (2) Background

### (a) Field of the Invention

The field of invention is edge analytics solutions. The term “edge analytics” is defined in “(15) DEFINITION OF TERMS”, contained herein.

### (b) Background

This section should be read in conjunction with “(11) NON-OBVIOUSNESS OF THE PRESENT INVENTION'S METHODOLOGY”, contained herein, which provides detailed background information for the present invention.

Existing edge analytics solutions are not able to solve optimization problems at the scale and level of complexity which are required by many real-world applications. The present invention can overcome this limitation, while providing many other benefits beyond those provided by existing edge analytics solutions.

The term “optimization problem” is defined in “(15) DEFINITION OF TERMS”, contained herein.

### BRIEF DESCRIPTION OF DRAWINGS

FIG. 1—Operational context for the present invention

FIG. 2—Grouping network fog nodes across problem spaces

FIG. 3—Uploading data to the network core

FIG. 4—Reformulating a flat analytical problem as a hierarchically decomposed mathematical program

FIG. 5—Mathematical program decomposition block-angular structure and network fog nodes

FIG. 6—Hierarchical mathematical program decomposition block-angular structure and network fog nodes

FIG. 7—Deploying components to network fog nodes

FIG. 8—Network fog nodes with or without built-in decomposed mathematical program solvers

FIG. 9—Basic information scheme

FIG. 10—Early start information scheme

FIG. 11—Early termination information scheme

FIG. 12—Intermediate prices information scheme

FIG. 13—Dynamic reconfiguration facility

FIG. 14—Subproblem roaming facility

FIG. 15—Process flow for dynamic reconfiguration and subproblem roaming

### DETAILED DESCRIPTION OF THE INVENTION

The present invention now will be described more fully hereinafter with reference to the accompanying drawings, which are intended to be read in conjunction with this detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete, and will fully convey the full scope of the invention to those skilled in the art.

The present invention is directed to an information processing architecture for network edge-based optimization problems.

In its most complete and preferred version, the present invention supports the following components and functionality:

### (1) Purpose, Operational Context, and Embodiment of the Present Invention

The present invention is an information processing architecture which is made up of the following components and processes, all of which are required in all versions:
1. Device-side components that operate on network edge nodes;
2. Server-side components operate on network edge nodes or network core nodes;
3. An information processing architecture that utilizes mathematical program decomposition, as described in “(6) EDGE ANALYTICS AND MATHEMATICAL PROGRAM DECOMPOSITION”, contained herein, as a means of solving optimization problems on network fog nodes;
4. Dynamic reconfiguration components that dynamically configure the information processing architecture. For example, a dynamic reconfiguration component might cause groups of network fog nodes to be dynamically created and modified, so that these groups can come together to solve a problem, and then be dynamically reassembled in different configurations in order to solve other problems.

It should be noted that the terms “network edge node”, “network core node”, “network fog nodes”, “mathematical program”, “mathematical program decomposition”, “optimization problem”, and “dynamic reconfiguration component” are defined in “(15) DEFINITION OF TERMS”, contained herein.

The information processing architecture may also be made up of the following optional components and processes:
1. Information processing components that support tuning techniques that optimize the performance and/or scalability of the information processing architecture, by providing functionality that may include but is not limited to: Dantzig-Wolfe decomposition information schemes, mathematical program decomposition information schemes, warm start components, presolver components, and multi-tier hierarchical decomposition structures. The tuning techniques are described in “(9) TUNING SOLVERS FOR EFFICIENT SOLUTION CONVERGENCE”, contained herein.
2. Subproblem roaming components that enable a network edge node, which might be a mobile network edge node such as a smart truck, to move from one decomposed mathematical program subproblem to another. Subproblem roaming is described in “(10) SUBPROBLEM ROAMING”.
3. Inward facing optimization components that automatically improve the functioning of the dynamic reconfiguration components. Inward facing optimization is described in “(8) DYNAMIC RECONFIGURATION”.

It should be noted that the terms “Dantzig-Wolfe decomposition information schemes”, “mathematical program decomposition information schemes”, “inward facing optimization”, “presolver component”, “subproblem roaming”, “warm start component”, and “multi-tier hierarchical decomposition structures” are defined in “(15) DEFINITION OF TERMS”, contained herein.

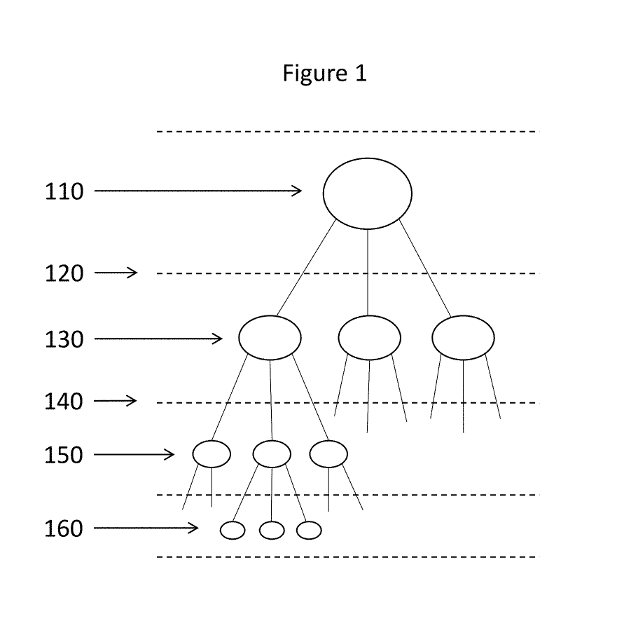

FIG. 1, “OPERATIONAL CONTEXT FOR THE PRESENT INVENTION”, provides a high-level view of the operational context for the present invention. The network architectures utilized within real-world implementations may be more complex than shown in FIG. 1. For example, callout 130, “Network edge servers”, may consist of multiple hierarchical server layers, connected via a wide variety of wired, wireless, and optical communications technologies. As another example, callout 150 “Network edge devices” may utilize complex networking architectures—such as those found within mesh networks, M2M solutions, or near-me area networks (NAN).

The present information processing architecture may be embodied in various forms, including but not limited to: software, Field Programmable Gate Array (FPGA), System-on-a-Chip (SOC), firmware such as ROM, EPROM, Flash, and other software, firmware, or hardware forms.

### (2) Capability to Work Across Problem Spaces while Operating at the Network Edge

The present invention provides the capability to perform data analytical functions across multiple problem spaces, while operating primarily or entirely on network edge nodes. This capability is a key innovation of the present invention. This capability can provide significant value across virtually all industry verticals.

A “problem space” is defined herein as an optimization problem area that is relatively narrow in scope and relatively consistent in nature. For example, the problem of routing smart big-rig trucks might represent a single problem space. On the other hand, the routing of smart big-rig trucks, the related scheduling of smart warehouse resources, the related allocation of smart delivery trucks, and the related ordering processes for smart retail outlets, represent different, but interrelated, problem spaces. Real-world problem spaces might be more narrowly defined or more broadly defined than these examples.

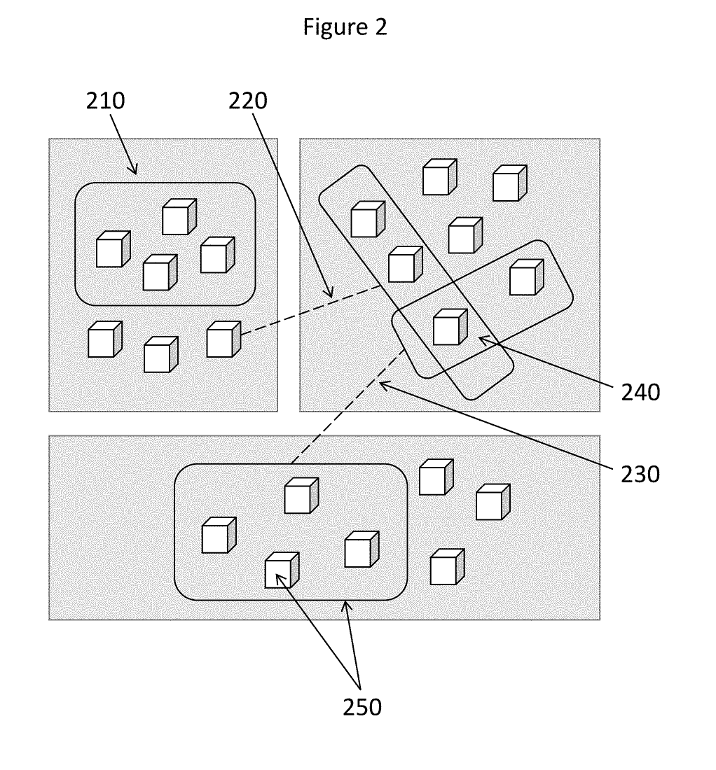

Problem spaces are illustrated in FIG. 2 “GROUPING NETWORK FOG NODES ACROSS PROBLEM SPACES”, and described in more detail in the description for FIG. 2 in “(14) DETAILED DESCRIPTIONS OF THE DRAWINGS”.

### (3) Features and Benefits of the Present Invention

The features and benefits of the present invention typically include the following, but are not required to include the following, and are not limited to the following:
1. Reduction of the utilization and costs associated with wireless networks—The wireless networks shown in FIG. 1, “OPERATIONAL CONTEXT FOR THE PRESENT INVENTION”, and described in “(14) DETAILED DESCRIPTIONS OF THE DRAWINGS”, represent an example of where wireless networks, such as cellular wireless networks, may be deployed within the operational context of the present invention. While this is only an example, it is common for wireless networks to be used as shown in FIG. 1. There are potentially significant costs associated with utilizing such networks, especially when large amounts of data must be uploaded from the devices and sensors to the higher levels of the architecture. Because the present invention is able to perform data analytics operations without uploading data to the higher levels of the network, it is able to reduce data traffic on wireless networks, and also reduce the associated costs.
2. Reduction of network core utilization and costs—The cloud services and/or datacenter facilities at the network core layer, shown in FIG. 1, involve potentially significant costs when centralized data analytics solutions are employed. This is especially true as large amounts of data are uploaded and analyzed by utilizing the network core services. The present invention can reduce the amount of uploaded data and reduce the utilization of centralized data analytics systems, and thus reduce the associated costs. These costs typically include, but are not limited to: compute, networking, storage, software, services, facilities, and personnel costs.
3. Protection of sensitive data—The present invention can perform data analytics functions that discover valuable knowledge, while avoiding the privacy invasion issues related to the transport of sensitive data (such as user behavior data) across networks, and the storage of this type of data within centralized locations. In fact, it is possible with the present invention to provide the value of data analytics and machine learning—such as intelligently targeted web ads, vehicle-to-vehicle safety functions, many other applications—without sharing or persisting any user behavior data in any centralized system.
4. Rapid responsiveness to real-world events—Since the present invention is able to produce analytical insights directly on devices, and even directly on smart sensors and actuators, it can provide rapid, potentially near real-time, responsiveness to real-world events. This capability is a critical requirement for many existing and emerging applications. The present invention can typically respond more quickly to real-world events than would be possible with a centralized data analytics solution.
5. Enablement of multi-organization solutions—The present invention can support scalable multi-organization and multi-industry analytical solutions. It can do so while allowing all participating organizations (such as enterprises) to maintain control over sensitive internal data. These kinds of large-scale solutions can provide significant efficiency gains and other benefits that cannot be achieved with single-organization analytical solutions. The present invention can provide significant value for these types of applications, since companies are generally reluctant to export sensitive internal data to company-external repositories, even when guarantees are in place to ensure that such data will remain secure and private. In fact, it may not be practical or even possible to create a centralized collection of data from thousands of companies as the quantity of business and industry data expands over time. Yet, such a centralized data repository would be necessary when using traditional centralized approaches to analyze large amounts of multi-organizational data wholistically. The present invention provides a way to around this dilemma by enabling flexible and finely granular distributed solutions that can run on and across very large numbers of network fog nodes, and potentially across multiple diverse problem spaces.
6. Enablement of data analytics directly within applications and devices—The present invention can optionally be embodied in firmware and hardware components, including but not limited to Field Programmable Gate Arrays (FPGA) and System-on-a-Chip (SOC) products. This enables networked device products, such as cyber-physical systems that are built by using embedded electronics, to offer turnkey application-specific data analytics features that work across potentially large numbers of connected products, while enabling customers of those products to reduce costs, such as costs related to cloud services, network data plans, and data storage services. It is possible to embody the present invention in hardware and firmware in part because it utilizes “mathematical program solvers”, described in “(6) EDGE ANALYTICS AND MATHEMATICAL PROGRAM DECOMPOSITION”, contained herein. This approach can be applied to a wide variety of analytical problems, including but not limited to: regression, clustering, classification, optimization, and other types of analytics problems. Yet, the present invention provides a single, compact, widely applicable solution, which only requires a relatively simple and compact textual problem definition (called a “mathematical program”) in order to be targeted at different analytical problems. In part because of this, the client side component of the present invention can be embedded into firmware or hardware with a relatively small memory footprint, and yet can provide significant and wide-ranging value to network devices and cyber-physical systems.
7. Capability to support dynamic groupings of network fog nodes—The present invention enables dynamic grouping of network fog nodes for the purpose of enhancing the effectiveness and efficiency of edge analytics. Such groups of network fog nodes can be created, modified, and dissolved dynamically, and can span across problem spaces. Such groups enable more operationally efficient, less expensive, more flexible, more responsive, and more effective analytical processing than may be possible with centralized analytical approaches. For example, machine learning processes can operate continuously in the background on network fog nodes, thereby providing finely granular localized knowledge, which is applicable even within broader contexts. As another example, the present invention can enable local weighting/biasing of analytical results within such groups and/or on individual network fog nodes, where the degree of local weighting/biasing may be optimized overtime within complex and quickly evolving contexts. This can be very valuable for creating large-scale dynamic analytical applications, and would likely be difficult to mimic with centralized approaches, especially as the quantities of data that must be processed grow extremely large. This dynamic grouping capability enables applications that utilize the present invention to adapt more efficiently and effectively to evolving application requirements and real-world events.
8. Capability to dynamically evolve complex and wide ranging analytical processing operations—The present invention enables the dynamic deployment of new mathematical programs—including but not limited to: linear programs, mixed integer linear programs, non-linear programs, and mixed integer non-linear programs—as necessary, in order to update or reconfigure the current analytical processing operations within an edge analytics solution. The ability of the present invention to support mixtures of many mathematical programs across many network fog node groups, and across multiple problem spaces, and to dynamically evolve those mixtures of mathematical programs, makes it possible to create very flexible and adaptable analytical solutions. The present invention supports high levels of flexibility and adaptability in the emerging IoT paradigm, and does so more effectively than is likely to be possible with centralized data analytical systems. Furthermore, the use of mathematical programs as the means of describing the analytical goals of edge analytics applications offers a level of ease-of-use that is not available with approaches that require coding of algorithmic steps in a computer language.

### (4) Network Fog Node Groups

The present invention enables network fog nodes to work together within groups, in order to solve analytical problems that span across the members of a group. The groups can be dynamically configured. For example, network fog nodes can be added to the groups and removed from the groups as required at runtime. Other aspects of the groups can also be dynamically modified at runtime, including but not limited to: the solvers that are selected to be run on the network fog nodes within a group, the frequency that iterative cycles between a reduced master problem and a set of subproblems are run within a group, and the length of time that data should be cached on network fog nodes within a group.

Said groups can exist within a problem space and/or can span across two or more problem spaces, as shown in FIG. 2, “GROUPING NETWORK FOG NODES ACROSS PROBLEM SPACES”. The present invention is able to leverage the groups that span across problem spaces in order to solve analytical problems which, themselves, span across multiple problem spaces, and to do so in a practical manner, both in terms of cost and operational efficiency, while operating mostly or entirely on network edge nodes.

### (5) Node-Internal Problems Vs. Node-Interaction Problems

Some problem variables and data are related only to the internal functions within a network fog node, while other problem variables and data are related to the interactions among network fog nodes. This is illustrated in FIG. 2 callout 250. For example, a smart truck might need to analyze internal variables and data related to the continuous readings of tire pressure, fuel level, and road grade sensor values, in order to optimize functions that are specific to that truck, whereas a smart truck and a smart warehouse might need to jointly analyze variables and data related to the delivery schedule that must be agreed upon between them, in order to optimize the delivery process within the context of the overall order shipment requirements.

For a broad range of applications within the emerging paradigm of connected cyber-physical systems, relatively fewer problem variables and data must be analyzed in order to solve the analytical problems involving the interactions between network fog nodes, when compared to the number of variables and amount of data that must be analyzed by a network fog node for purely internal purposes. For example, analyzing the data that is received continuously from multiple sensors within a smart truck, in order to optimize the truck's performance internally, generally requires significantly more computing resources when compared to the relatively fewer computing resources that are required to simply setup a delivery schedule in coordination with a smart warehouse. This difference between the quantity of variables and amount of data that must be processed to solve node-internal vs. node-interaction problems has a very important implication for the current invention: Because of this, mathematical program decomposition can be naturally and effectively applied to solve edge analytics problems across diverse problem spaces. This is due to the fact that the mathematical program decomposition principle can only be effective when the overall data analytics problem can be decomposed into a reduced master problem and a set of independent subproblems, where the reduced master problem (the node-interaction problem) must not be too difficult to solve relative to the independent subproblems (the node-internal problems). This is covered in detail in Dantzig [2].

Since most analytical problems related to networked cyber-physical systems are able to fit easily into the requirements for the mathematical program decomposition principle, that principle is naturally applicable to edge analytics across diverse problem spaces. This fundamental insight is unique to the present invention, and is non-obvious, as described in “(11) NON-OBVIOUSNESS OF THE PRESENT INVENTION'S METHODOLOGY”, contained herein.

### (6) Edge Analytics and Mathematical Program Decomposition

The present invention utilizes “mathematical program decomposition” in order to enable edge analytics functionality across multiple problem spaces. The widely used term “mathematical program” does not refer to a computer program in the common sense. Rather it refers to a way of expressing the goals of an analytical problem. The formulation of a mathematical program typically includes an objective function and a set of constraints often expressed as inequalities. [2] [4] [5] There are several types of mathematical programs, including but not limited to: linear programs, mixed integer linear programs, non-linear programs, and mixed integer non-linear programs. While a mathematical program, itself, only describes the problem to be solved, a set of processing instructions, called the “solver” for the mathematical program, is used to find the optimal solution for the mathematical program.

The notion of decomposing a mathematical program typically involves breaking up the overall problem into 1) a “reduced master problem”, and 2) a set of independent “subproblems”. There are a number of different approaches to mathematical program decomposition. [1] [2] [3] [4] [5]

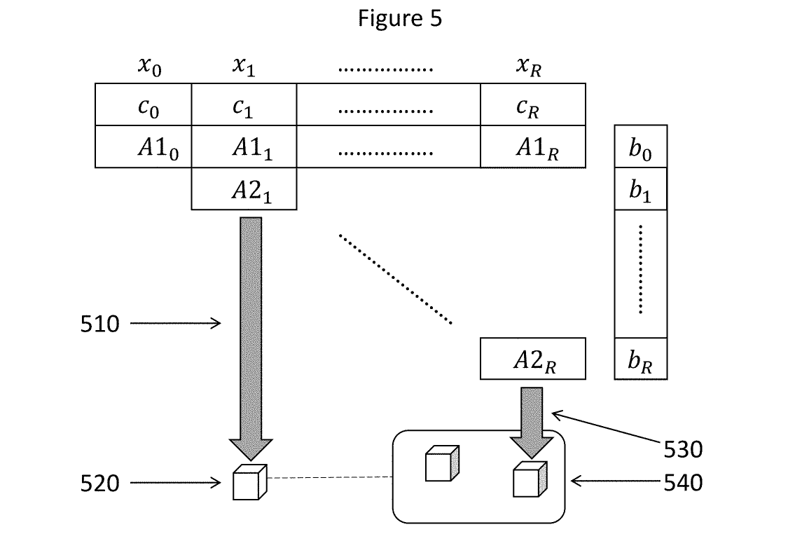

FIG. 5 “MATHEMATICAL PROGRAM DECOMPOSITION BLOCK-ANGULAR STRUCTURE AND NETWORK FOG NODES” introduces the linear program decomposition method, known as Dantzig-Wolfe decomposition—which is a form of mathematical program decomposition—and also introduces the way that the present invention associates a decomposed mathematical program with network fog nodes. See the detailed description of FIG. 5 in “(14) DETAILED DESCRIPTIONS OF THE DRAWINGS”. For the sake of simplicity, this present specification focuses primarily on Dantzig-Wolfe decomposition. However, the scope of the present invention encompasses all mathematical program decomposition approaches that are mathematically equivalent to Dantzig-Wolfe decomposition. These methods include, but are not limited to: Benders Decomposition and Lagrangian Relaxation. The mathematical equivalence between these methods on Dantzig-Wolfe decomposition is described in Lim (2011) [12].

With the present invention, the overall data analytics problem is decomposed into a reduced master problem which is solved on network fog nodes, and a set of independent subproblems which are solved on network edge nodes.

In order for a problem to be effectively solved in this manner, the problem must have the characteristics described in “Node-Internal Problems vs. Node-Interaction Problems”, contained herein.

As shown in FIG. 5, decomposing a mathematical program which fits the above stated requirements yields a block-angular matrix structure. The A1 blocks in FIG. 5 specify the reduced master problem, and represent the coupling constraints between the subproblems, which is the node-interaction problem. The A2 blocks within the block angular structure in FIG. 5 specify the independent subproblems, which are the node-internal problems.

As shown in FIG. 5, the block-angular structure corresponds to the network fog nodes where edge analytics processing will occur. It should be noted that each block in the block-angular structure may be made up of multiple columns within the overall matrix, where those columns represent problem variables, such as a truck's fuel level, tire pressure, and trailer weight.

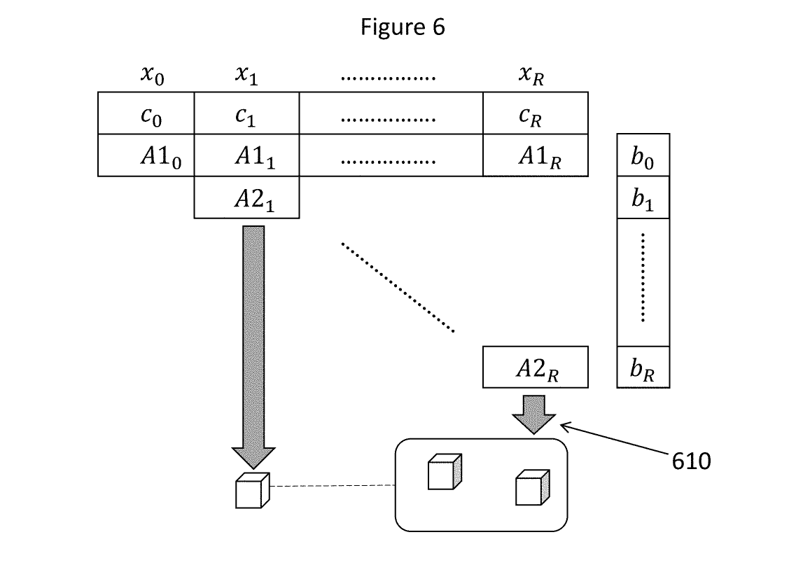

In FIG. 6, the A1 row represents the coupling constraints that affect multiple network fog nodes potentially in different problem spaces. For example, aspects of the A1 row may represent shipment schedules that constrain both warehouse decisions and trucking decisions. The mathematical program solver for the reduced master problem is concerned with generating columns (the variables to be considered) for the A1 row during each iteration between solving the reduced master problem and solving the independent subproblems. The reduced master problem solver only includes those columns that can potentially further optimize the current best solution. This makes it possible to find the optimal solution more quickly and with fewer computational resources than would otherwise be possible. The details for how Dantzig-Wolfe Decomposition generates columns is a complex topic that has been addressed in several texts, such as [1], [2], [4], [5].

It should be noted that Dantzig-Wolfe Decomposition provides a particularly elegant and effective means of performing column generation, and thus provides great value to the present invention. This is due to that fact that effective column generation makes it possible to solve analytical problems at the network edge that span across diverse problems spaces, and to do so in a way that is computationally efficient and reduces network traffic. The reason that effective column generation makes this approach computationally efficient is that reducing the columns (problem variables) that the reduced master problem must consider during each iteration, enables the reduced master problem solver to find the optimal solution more quickly and efficiently. The reason that effective column generation causes this approach reduce network traffic is that fewer iterations between solving the reduced master problem and solving the subproblems are required to reach a sufficient level of optimality, and this reduces the number of times that analytical results need to be communicated over the network between the reduced master problem and the subproblems.

In FIGS. 5 and 6, the A2 rows—which make up the block-angular structure—represent the independent subprograms that define the internal processing within network fog nodes. For example, A2sub1 might represent a smart truck's internal processes such as trucking route selection, and A2sub2 might represent a warehouse's internal processes such as product stocking and pricing decisions.

In FIG. 5 callout 530, the A2subR block in the block angular structure shows how a block can represent an individual network fog node. In FIG. 6 callout 610, the A2subR block in the block angular structure shows how a block can represent the results from a hierarchically lower group of network fog nodes. The hierarchically lower level analysis can be performed in multiple ways, including but not limited to representing the hierarchically lower level problem as a separate mathematical program and solving it independently of the hierarchically higher level problem. This hierarchical problem solving feature of the present invention dramatically increases its ability to address large-scale and complex analytical problems, which will be common in the emerging paradigm of networked cyber-physical systems.

### (7) Dynamic Deployment Facility

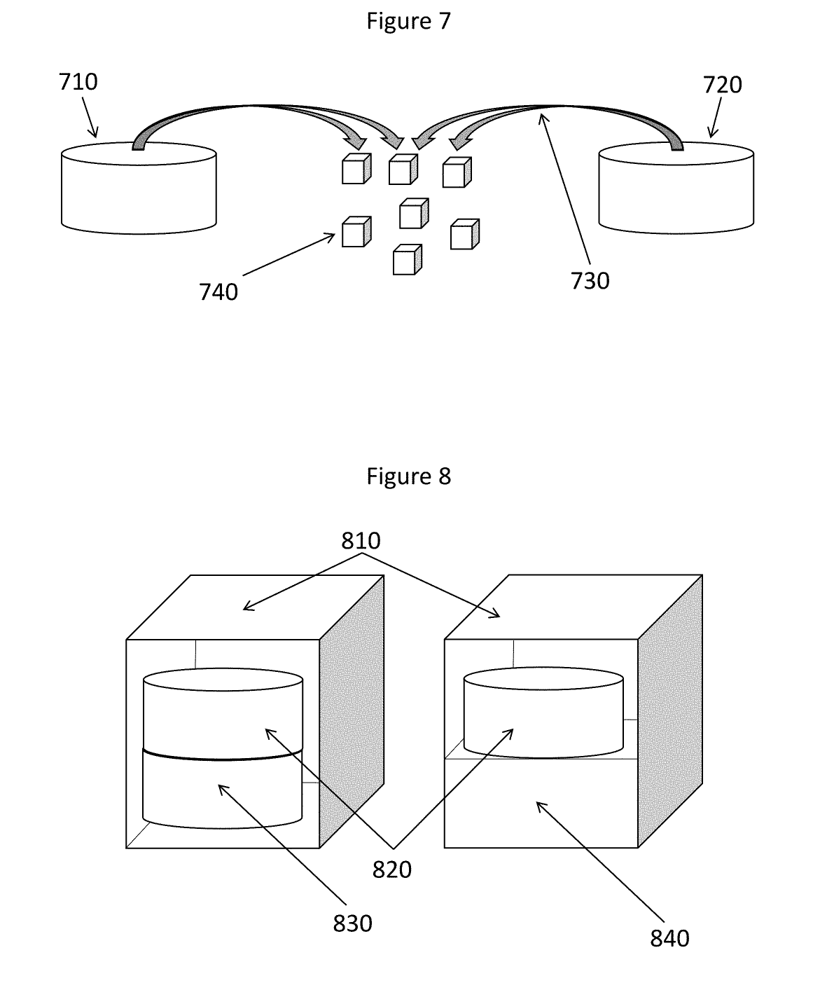

As shown in FIG. 7, “DEPLOYING COMPONENTS TO NETWORK FOG NODES”, mathematical programs and solvers can be deployed to network fog nodes. A mathematical program is a specification of the problem that is to be solved, such as linear program. Many texts describe how to formulate a mathematical program (e.g. [2], [4], [5]). A solver is information processing instructions that finds the optimal solution to the mathematical program that is presented to it.

As shown in FIG. 8, “NETWORK FOG NODES WITH OR WITHOUT BUILT-IN DECOMPOSED MATHEMATICAL PROGRAM SOLVERS”, the deployment architecture could be used in different ways. For example, solvers can be dynamically disseminated as needed and/or could be built into the software, hardware, or firmware of the network fog nodes where those solvers are to be utilized. It should be noted that building solvers into devices can result in easy-to-use and very powerful devices, such as cyber-physical systems, which are flexible, modular, and easy to incorporate into large-scale and dynamic applications that require edge analytics functionality.

### (8) Dynamic Reconfiguration Facility

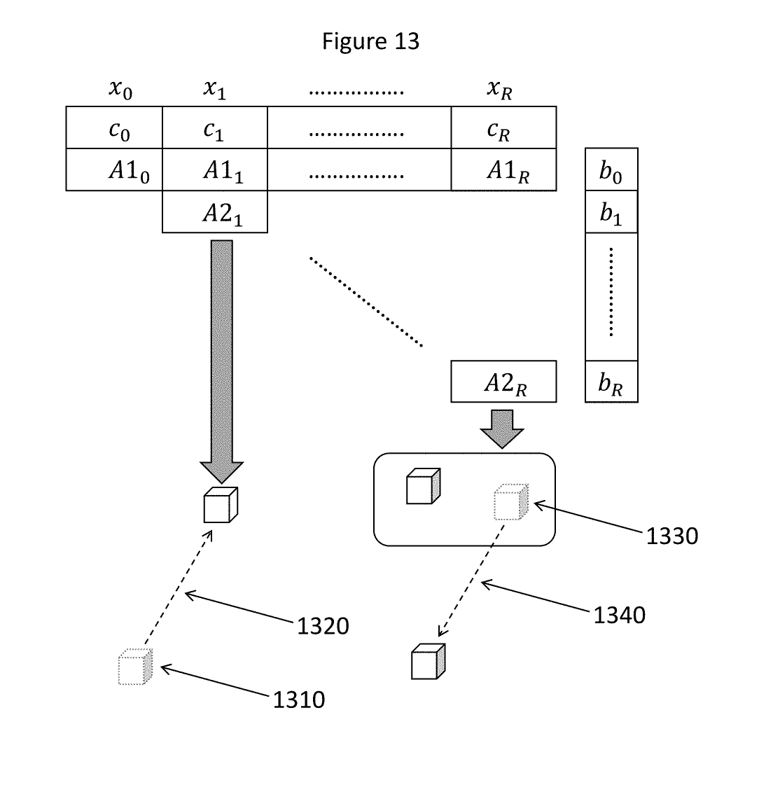

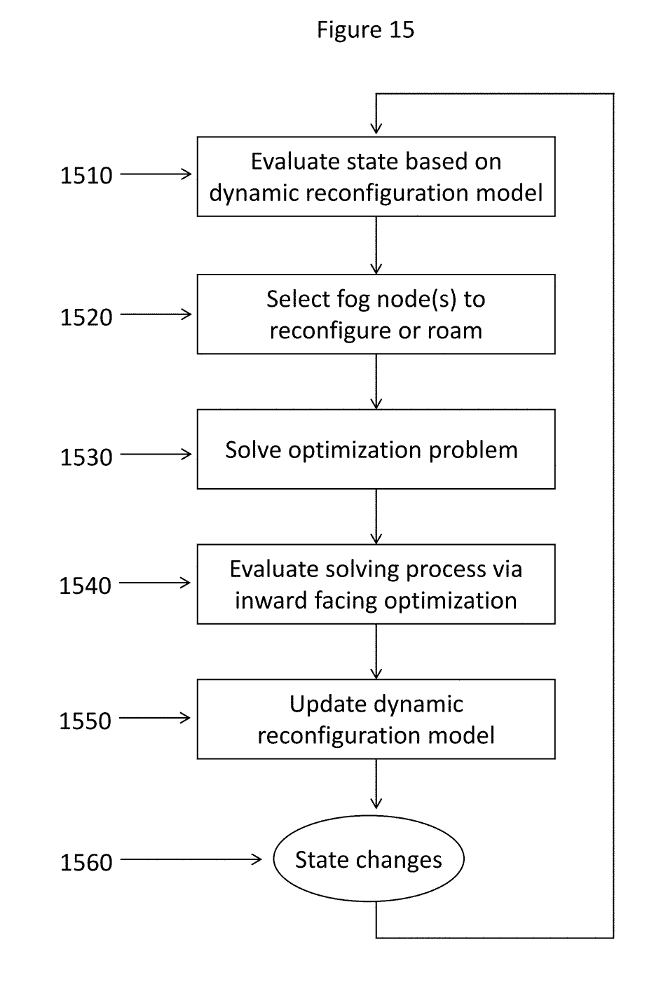

This section should be read in conjunction with FIG. 13, “DYNAMIC RECONFIGURATION FACILITY”, and FIG. 15, “PROCESS FLOW FOR DYNAMIC RECONFIGURATION AND SUBPROBLEM ROAMING”, and their descriptions in (14) DETAILED DESCRIPTION OF THE DRAWINGS.

The present invention provides a dynamic reconfiguration facility, which is implemented by a dynamic reconfiguration component.

In the simplest case, the dynamic reconfiguration facility can be thought of as the capability to reconfigure the components of the present invention at runtime, including but not limited to: 1) assigning network fog nodes to groups; 2) dissemination of decomposed mathematical programs; and 3) invocation of decomposed mathematical program solvers.

However, the dynamic reconfiguration facility goes well beyond this basic capability, and can offer a type of “intelligent swarming” capability, which closely links the logical problem of decomposed mathematical program solving to the dynamic characteristics of the operational environment and the state of the analytical problems that are being solved. This enables potentially large numbers of network fog nodes to continuously and automatically rearrange themselves into functional groups quickly and efficiently, in order to solve dynamically evolving problems in real-world scenarios.

The ways in which the dynamic reconfiguration facility links decomposed mathematical program solving to the dynamic characteristics of the operational environment and the state of the analytical problems that are being solved include, but are not limited to:
(1) Consideration of the geolocation of network fog nodes in regard to the applicability of those network fog nodes to the efficient solving of particular decomposed mathematical program subproblems. For example, if the data streams for certain network fog nodes are likely to be more relevant to a particular subproblem, due to the geolocation of the sources of those data streams, then the dynamic reconfiguration facility can assign those network fog nodes to that subproblem. This amounts to including columns in the corresponding reduced master problem and subproblem for those network fog nodes that are added. This method of simply adding columns to the reduced master problem and subproblem, in order to solve dynamically evolving and potentially large-scale and complex optimization problems, amounts to an easy-to-use and fully generalizable method that is extremely powerful and scalable, and can be extended to all sorts of real world problems in a consistent way. These resulting benefits are extremely valuable within the emerging IoT paradigm, and are non-obvious benefits of the presently described dynamic reconfiguration facility.
(2) Consideration of the relevancy of data stores on network fog nodes in regard to the applicability of those network fog nodes to the meaningful and accurate solving of particular decomposed mathematical program subproblems. This consideration can feed into the determination of which columns to add to the corresponding reduced master problem. For example, if certain useful columns are under represented within or missing entirely from the reduced master problem, and if particular network fog nodes contain large quantities of historical data or models that bear on those columns, then the dynamic reconfiguration facility can assign those network fog nodes to that subproblem. It should be noted that the same consistent method of simply adding columns to the reduced master problem is used, as with the previous example, above. Thus, this simple and consistent method of addressing large-scale and evolving optimization problems can be applied across different “dimensions”, such as the geolocation of network fog nodes as well as the internal characteristics of the network fog nodes.
(3) There are many other such considerations, including but not limited to: 1) the status of network fog nodes, including but not limited to: low power mode, online/offline, battery charging level, and network connectivity status, in consideration of how these status values affect the effectiveness of the network fog nodes for solving the required subproblems; 2) software and/or hardware capabilities of network fog nodes, for example as this might apply to the capacity of network fog nodes to complete cycles of subproblem solving in accordance with the application requirements; 3) proximity of a network fog node in relation to other network fog nodes, in cases where such proximity bears on the effectiveness of the network fog nodes to act as a group when solving a particular decomposed mathematical program; 4) current processing load on a network fog node, in relation to how that affects the network fog node's ability to handle the computations that are required to solve a particular decomposed mathematical program; 5) the nature and quantity of the internal columns within particular network fog nodes, such as robots that have very complex internal columns vs. smart thermostats that have relatively simple internal columns, and how this bears on the proper balance between the columns on the subproblem nodes and the columns on the reduced master problem nodes, given the fact that this balance is critical to effectively solving decomposed mathematical programs, for example by reducing the number of iterations between the reduced master problem solver and the subproblem solvers.

It should be noted that machine learning techniques can optionally be applied within the dynamic reconfiguration facility in order to automate much of its processing. In fact, the very capabilities of the present invention can be as use “inward facing optimization” features, in order to provide these machine learning facilities. For example, in order to use machine learning to determine that the columns on a particular network fog node are “helpful” for a given subproblem, the network fog nodes, themselves, can use their built-in optimization capabilities, and may potentially do so through background processing. This could, for example, take the form of a clustering or nearest neighbor problem, implemented as an optimization problem, and solved though mathematical program decomposition, in the background across a set of candidate network fog nodes. This approach to creating an intelligent dynamic reconfiguration facility across network fog nodes is very innovative and powerful, and no similar prior art is known to exist.

### (9) Tuning Solvers for Efficient Solution Convergence

In the present invention, the process of solving decomposed mathematical programs can be optimized, scaled, and otherwise enhanced via a number of techniques, including but not limited to:

(9.1) Information Schemes

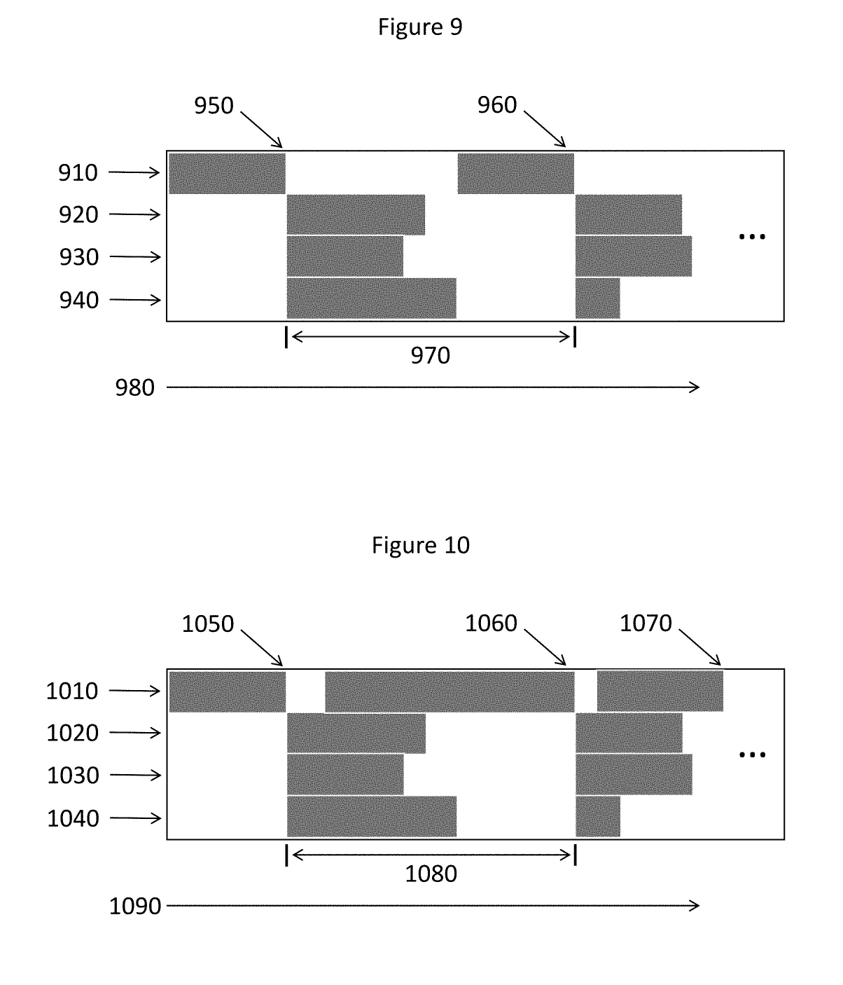

Dantzig-Wolfe decomposition information schemes were originally proposed by Ho[3], and were intended to enhance the performance of Dantzig-Wolfe decomposition solvers. The present invention extends the notion of information schemes more widely to the solvers for all forms of mathematical program decomposition that are mathematically equivalent to Dantzig-Wolfe decomposition. This section is intended to be read in conjunction with the detailed descriptions for FIGS. 9, 10, 11, and 12 in the section “(14) DETAILED DESCRIPTIONS OF THE DRAWINGS”, contained herein.

Information schemes affect the timing of the interactions between the reduced master problem solver and the subproblem solvers. For example, rather than waiting for all subproblem solvers to return results before the reduced master problem can begin processing the output of the subproblem solvers, an information scheme can configure the reduced master problem to execute in parallel with some of the subproblems. An important insight for the present invention, is that the tradeoffs that have been studied for Dantzig-Wolfe decomposition information schemes can be very relevant to solving decomposed mathematical programs where the reduced master problems and the subproblems are located on network fog nodes, especially given the dynamic nature of emerging IoT edge analytics problems. Compared to the traditional use cases for information schemes, the present invention uses information schemes not simply for increasing the performance of the process of solving decomposed mathematical programs, but also to provide additional value that includes, but is not limited to, 1) optimizing performance in situations where there are unreliable or intermittent wireless connections to the network fog nodes; and 2) optimizing performance in situations where wireless devices may have gone offline; and 3) optimizing performance in situations where the subproblem solvers on some nodes take longer to complete a cycle than on other nodes, for example because more data is processed on some network fog nodes than on others, or because some network fog nodes have slower processors than others; and 4) optimizing performance in situations where historical evidence shows that it is not necessary to retrieve the results from all the network fog nodes in order to arrive quickly at a solution that provides a sufficient level of optimality for the application; and 5) optimizing performance in dynamic real-world environments, where network fog nodes are being added to solutions and removed from solutions frequently, and where the nature of the data streams and other external factors continually evolve, and where such considerations warrant a flexible and dynamically modifiable approach to obtaining results from the subproblems running on the network fog nodes; and 6) additional considerations related to the operational context of the present invention.

The application of mathematical program information schemes within the present invention also provides a flexible mechanism that can be dynamically adjusted to increase the efficiency of the solution in contexts such as emerging IoT scenarios, based on factors including, but not limited to: 1) the relative complexity of the subproblems vs. the reduced master problem; and 2) the number of network fog nodes involved in solving a particular problem; and 3) the similarity of the problems being solved by different nodes; and 4) additional considerations.

Optionally, the selection and application of mathematical program decomposition information schemes to particular scenarios, and similar uses of the mathematical program decomposition information schemes, can be intelligently automated by using the same process as can be used to intelligently automate dynamic reconfiguration and subproblem roaming, as described in “(14) DETAILED DESCRIPTIONS OF THE DRAWINGS”, FIG. 15 “PROCESS FLOW FOR DYNAMIC RECONFIGURATION AND SUBPROBLEM ROAMING”.

The following examples show how the present invention might select the best information scheme to use at any given time, by leveraging information about the operational context of the present invention. These are only examples. Many other approaches are possible.

In the first example: 1) Determine the average subproblem response times, taking into consideration their average network latency times; 2) Then determine the statistical dispersion of their response times (that is, high widely the response times differ across the fog nodes that are processing the subproblems); 3) If the level of dispersion is relatively low, and thus the subproblems all require about the same amount of time to complete, and if the network connections are reliable (so that long unexpected delays in receiving the results from any given subproblem are unlikely), and if the accuracy of the resulting master problem solver is highly sensitive to the number of subproblem solver results during any given cycle, then the Basic Information Scheme (BIS), described in “(14) DETAILED DESCRIPTIONS OF THE DRAWINGS”, FIG. 9 “BASIC INFORMATION SCHEME”, may be weighted more heavily as the preferred information scheme. This is because the BIS waits until all subproblem results have been returned before the master problem solver begins to process those results, and this would be an effective approach under the stated conditions.

As another example, if results are needed quickly, and the subproblems on certain nodes are prioritized, and those solvers tend to complete their cycles early, and the master problem solver can process new input as it comes in effectively—which is known as online machine learning—then the Early Start Information Scheme (ESIS), described in “(14) DETAILED DESCRIPTIONS OF THE DRAWINGS”, FIG. 10 “EARLY START INFORMATION SCHEME”, may be weighted more heavily as the preferred information scheme. This is because the ESIS does not wait until all subproblem results have been returned before the master problem solver begins to process those results, and this would be an effective approach under the stated conditions.

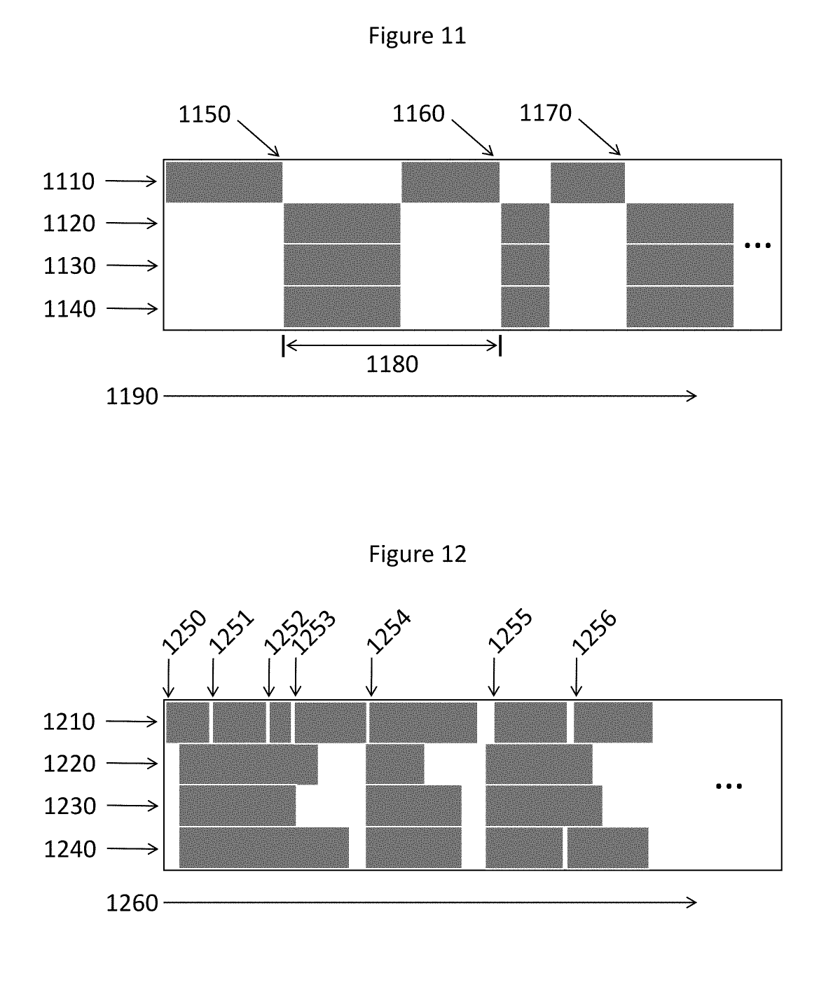

As another example, if the subproblem solvers on the fog nodes are heavily loaded and need to freed up as soon as possible (rather than spend too much time solving the subproblems), and most of the subproblem results are rather similar anyway (there is little dispersion in their results), and especially if network connections are intermittent or unreliable so that it doesn't make sense to keep waiting for all of the subproblems to return their results, and especially if shorter cycle times (of the iterations between the reduced master problem and the subproblems) equate to faster overall results at an acceptable level of optimality—then the Early Termination Information Scheme (ETIS), described in “(14) DETAILED DESCRIPTIONS OF THE DRAWINGS”, FIG. 11 “EARLY TERMINATION INFORMATION SCHEME”, may be weighted more heavily as the preferred information scheme. This is because the ETIS does not require all subproblem results, and in fact halts subprogram operations when a sufficient number of subproblems have returned results, and this would be an effective approach under the stated conditions.

As another example, if the network fog nodes need to be updated as soon as possible due to the dynamic nature of the data streams across the fog nodes, and widespread knowledge must be immediately conveyed to as many network fog nodes as possible, and especially if the subproblem solvers on the nodes can do online machine learning perhaps by weighting the current results against previous results, and especially if dynamic data stream values require fast continuous updating of machine learning models—then the Intermediate Prices Information Scheme (ETIS), described in “(14) DETAILED DESCRIPTIONS OF THE DRAWINGS”, FIG. 12 “INTERMEDIATE PRICES INFORMATION SCHEME”, may be weighted more heavily as the preferred information scheme. This is because the IPIS allows for complex inter-weaving of subproblem execution and reduced master problem execution, with very fast feedback loops between the reduced master problem and the subproblems, and this would be an effective approach under the stated conditions.

It is important to note, the present invention utilizes information schemes for decomposed mathematical programs in a unique and innovative way that can add significant value to a network edge-based optimization solution. It does this by linking any and all aspects of the operating environment—including but not limited to the nature of the data streams and the conditions on the network fog nodes—to the interactions between the reduced master problems and subproblems for decomposed mathematical programs. When decomposed mathematical programs are solved by column generation (or row generation), these kinds of information schemes are a particularly powerful performance enhancement technique within the operating context of the present invention. This is in part due to the fact that many different categories of factors, such as network status and data stream characteristics and many other factors, can all be seamlessly integrated into a performance enhancement solution where all such factors are treated consistently, simply as columns within a decomposed mathematical program. That is, no special considerations are required for each type of factor. This is especially valuable within complex contexts such as the emerging IoT paradigm, where a vast diversity of such factors will be continually at play.

(9.2) Mathematical Program Warm Starts

Decomposed mathematical program warm starts are appear in the published literature, for example L. E. Sokoler et al, 2014 [14]. Warm start techniques with decomposed mathematical programs use a previously successful solution and a set of basis columns (that is, the decision variables that are being considered in the current iteration) as the starting point for the reduced master program solver. The use of warm start techniques can help to solve decomposed mathematical programs much more quickly. The present invention should benefit greatly by using warm start techniques, due to the fact that the optimization problems that are solved by a particular real-world application tend to be similar over time, but with dynamically changing state variables. In this context, warm starting the mathematical program solvers should be very effective. Over time, as more and more experience is gained in real-world applications, the application of warm start techniques should become increasingly effective.

(9.3) Hierarchical Mathematical Program Decomposition Structures

When a mathematical program is decomposed, it is reformulated as a hierarchical structure, with a reduced master problem at the top of the hierarchy, and the subproblems at the bottom of the hierarchy. It is possible to extend this idea to multiple hierarchical levels, where a set of reduced master problems on one level of the hierarchy serve as subproblems for the reduced master problem on the next higher level of the hierarchy. This is described in the description of FIG. 6, “HIERARCHICAL MATHEMATICAL PROGRAM DECOMPOSITION BLOCK-ANGULAR STRUCTURE AND NETWORK FOG NODES”, in section “(14) DETAILED DESCRIPTIONS OF THE DRAWINGS”. The use of such hierarchies enables the present invention to scale to arbitrarily large and widespread optimization problems, that may encompass thousands of network fog nodes (or more).

(9.4) Mathematical Programming Presolving

Mathematical program presolving is a widely used technique to enhance the performance of mathematical program solvers. Presolving is described in many texts, for example Andersen et al (1993) [10]. A presolver component presents a mathematical program to a solver in a properly formulated form. There are some rules a properly formulated mathematical program must satisfy. It should contain as few variables, constraints, and non-zeros as possible, it must be well-scaled, and the constraints must be linearly independent. These rules are enforced by presolver components.

Presolving is important for the present invention due to the dynamic nature of the operational context and the wide variety of data types and analytical problems that are presented for optimization. Presolver components provide the services that help to manage the dynamic nature of real-world problems that arise, for example, in the emerging IoT context.

### (10) Subproblem Roaming

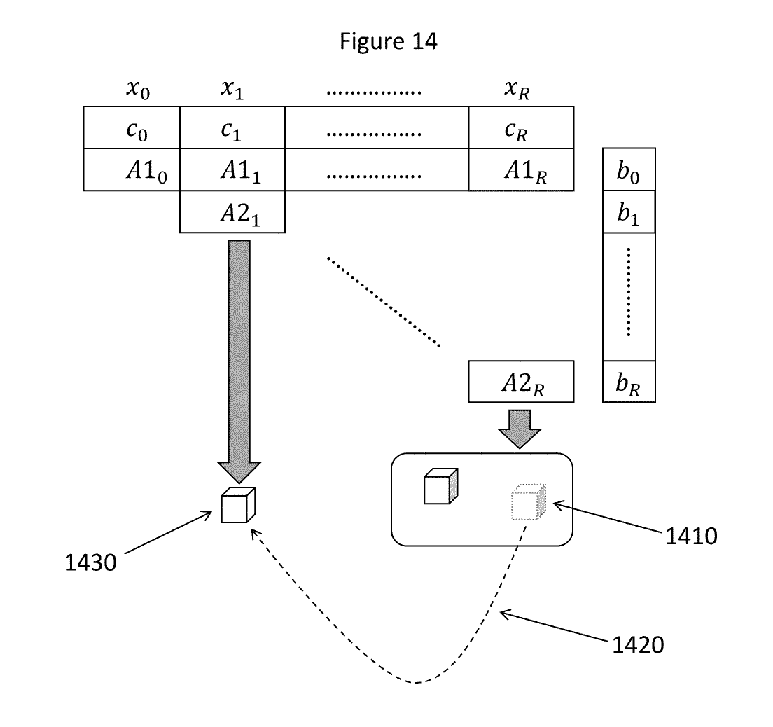

This section should be read in conjunction with FIG. 14 “SUBPROBLEM ROAMING” IN “(14) DETAILED DESCRIPTIONS OF THE DRAWINGS”.

Subproblem roaming is a unique innovation set forth herein, where a network edge node, which might be a mobile network edge node such as a smart truck, can move from one decomposed mathematical program subproblem group to another, based on any desired criteria, including but not limited to: the network fog node's geolocation, the network fog node's status (such as low power mode), the number of network fog nodes currently assigned to a particular subproblem vs. the number of network fog nodes currently assigned to a different subproblem, or other criteria.

The subproblems that a network edge node roams between may reside within the same problem space, or within different problem spaces. An example of subproblem roaming is a scenario where a smart truck helps to discover the traffic patterns within City A when that smart truck is physically located in City A, but then that smart truck roams to a separate decomposed mathematical program subproblem where it helps to map the traffic patterns within City B when it is physically located in City B.

Subproblem roaming is an important innovation that enables the current invention to solve large-scale real-world problems where, for example, different cyber-physical systems are relevant to different decomposed mathematical program subproblems at different times.

### (11) Non-Obviousness of the Present Invention's Methodology

The following discussion describes why the methodology of the present invention is non-obvious. This discussion focuses primarily on Dantzig-Wolfe decomposition, which is the most well-known approach to mathematical program decomposition. However, the rationale described here applies to any other mathematical program decomposition techniques which use column generation, or row generation, to solve decomposed mathematical programs.

The approach used by the present invention is non-obvious in part because of the history of mathematical program decomposition. When George Dantzig and Philip Wolfe introduced Dantzig-Wolfe decomposition in 1960 [1], the technique garnered a lot of attention. But early attempts to utilize it were considered disappointing, and the technique quickly fell out of favor. Some reasons for this are examined by Ho in 1986 [3], who notes that many researchers came to the conclusion that Dantzig-Wolfe Decomposition performs no better than a direct Simplex method (a non-decompositional method). Ho [4] notes:

“Since its introduction by George Dantzig and Philip Wolfe in 1960, the decomposition approach to large, structured linear programs has only met with limited success in practical applications . . . . Later on, because of tremendous advances in sparse matrix techniques for the revised simplex method, it became even more difficult to compete directly with commercial LP [linear programming] software.” Even years later, few attempts were made to reinvigorate Dantzig-Wolfe decomposition. In 2001, in a doctoral thesis, James Richard Tebboth [5] puts forth an argument that again highlights the limited acceptance of Dantzig-Wolfe decomposition within real world applications:

“Our work shows that if a reasonable block structure can be found, the decomposition method is worth trying. Dantzig-Wolfe decomposition will not rival mainstream techniques as an optimisation method for all LP (linear program) problems. But we do show that Dantzig-Wolfe decomposition has some niche areas of application: certain large scale classes of primal block angular structured problems, and in particular where the context demands rapid results using parallel optimisation, or near optimal solutions with a guaranteed quality.”

Today, mathematical program decomposition remains a very small specialty field, with only a handful of experts throughout the entire world. The approach is rarely used in real-world applications, and there are less than 40 patents in the PTO database that reference Dantzig-Wolfe decomposition (none of which have any relationship to the present invention).

It is worth noting that the mainstream techniques mentioned above, such as the highly parallelized Simplex methods noted by Ho, will not work in the network edge context. This is because these techniques require very fast network interconnects that transfer large amounts of data extremely quickly between compute nodes, at near zero cost. This approach cannot work across large networks, which generally include slow and costly wireless network links. Thus, the mainstream approaches to solving large-scale optimization problems—which historically won out over Dantzig-Wolfe decomposition for the purposes of traditional centralized analytical computing—would be far too unwieldly and slow if they were implemented at the network edge.

Futuristic approaches to network edge computing for the IoT are currently being developed by organizations such as the OpenFog Consortium [9], which is backed by many major industry players including Microsoft, ARM, Cisco, Dell, and Intel. Even with such industry-leading brands, the approach envisioned is still fundamentally similar to the existing computing paradigm, relative to what the present invention entails. For example, in OpenFog Reference Architecture for Fog Computing (February 2017), the OpenFog Consortium states:

“Locally stored operational history can be aggregated and sent to the cloud for large-scale analytics. These analytics can be applied to machine learning to create optimized models, which are then downloaded to the local fog infrastructure for execution.”

The above vision is precisely the approach of using centralized analytical systems for large-scale optimization problems. This is precisely what the present invention can overcome by performing such large-scale analytical operations directly on fog nodes, without uploading ever-growing amounts data to the centralized analytical systems.

It is important to emphasize that the above vision from the OpenFog Consortium comes from leading thinkers in the industry. These thinkers show no indication of grasping the utility of reformulating a flat analytical problem (on a set of fog nodes) into a hierarchical representation of that analytical problem, by using mathematical program decomposition—in conjunction with tuning techniques which enable the entire process operate quickly at scale. And yet, this approach can dramatically reduce the need to upload data to the cloud, which is a primary objective of the OpenFog Consortium. This adds very compelling evidence to support the claim that the present invention is non-obvious.

There are a small number of known published academic research papers that explore ideas that are related to the present invention:
In “Decentralized Coordination of a Building Manager and an Electric Vehicle Aggregator” Ocaña et al (2016) [15] address the use of Dantzig-Wolfe decomposition in a distributed architecture to “control commercial buildings and electric vehicles”.
In “Joint scheduling of large-scale appliances and batteries via distributed mixed optimization” Yang et al (2015) [16] address the “joint scheduling problem of large-scale smart appliances and batteries (e.g., in a smart building)”.
In “Distributed energy management of microgrids with Dantzig-Wolfe decomposition” Altay et al (2014) [17] address “distributed management of microgrids” to provide “energy management of interconnected microgrids”.

The above research papers, both individually and in aggregate, fall far short of disclosing the key enabling attributes of the present invention. In particular, no known prior art discloses the equivalent of the present invention's dynamic reconfiguration facility, described in “(8) DYNAMIC RECONFIGURATION FACILITY”, contained herein. The dynamic reconfiguration facility is what gives the present invention a type of “intelligent swarming” capability, which closely links the logical problem of decomposed mathematical program solving to the dynamic characteristics of the operational environment and the state of the analytical problems that are being solved.

It is important to emphasize that the differences between the present invention and the solutions envisioned in the referenced research papers have a profound impact, and enable the present invention to address general problems of much wider scope, and to do so successfully within dynamically evolving real-world applications of a general nature. Further, it is important to emphasize that the type of solution conveyed herein must be considered non-obvious, given that very few specialized researchers have considered ideas that have any relationship at all to the present invention, while this type of solution has totally escaped the attention of the leading industry thinkers who are charged with addressing the very general problems that the present invention solves, including those industry leaders associated with the OpenFog Consortium.

### (12) Using the Present Invention

The process of using the present invention involves the following steps:

a) Define the decomposed mathematical programs for the application at hand. This is a standard job that might be performed by a data analysis engineer, data scientist, operations research engineer, or mathematician.

b) Develop a software program that utilizes the present architecture via an API. This job might be performed by a software engineer.

c) Deploy the software application to the operational context shown in FIG. 1. This is a standard process that might be performed by an IT systems administrator.

The above description provides a simple, high level overview of the process of using the present invention. Clearly, software development and deployment is a widely understood process that is very complex and involves many detailed steps that are not described herein.

### (13) Making the Present Invention

The required networking and data management functionality for the present invention can be implemented via a variety of open source software systems, such as the Kaa platform (www.kaaproject.org) for networking infrastructure functions, CouchBase (www.couchbase.com) for database functions, and many other well-known open source projects. It would also be possible to implement the present invention by using proprietary software systems to provide this functionality, such as the C3IoT platform.

The mathematical program functions and mathematical program decomposition functions required by the present invention can be implemented as described in many published texts, including Dantzig [2], and Ho and Sundarraj [4], and by using open source solutions such as the COIN-OR project (an optimization suite, originally open sourced by IBM in 2000).

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

### (14) Detailed Description of Drawings

### FIG. 1—Operational Context for the Present Invention

### Description

This drawing shows the network architecture that the present invention operates within.

It should be noted that: 1) Network core nodes include any nodes deployed to the layer designated by callout 110 in FIG. 1; and 2) Network edge nodes include any nodes deployed to the layers designated by callouts 130, 150, and 160 in FIG. 1; and 3) Network fog nodes include any nodes deployed to the layers designated by callouts 130, 150, and 160 in FIG. 1, and optionally include any nodes deployed to the layer designated by callout 110 in FIG. 1.

Callouts:

110: Network core—This includes, but is not limited to, enterprise servers, high performance computing (HPC) clusters, and cloud services.

120: Infrastructure between the network core and the network edge—This includes, but is not limited to, optical networks, metropolitan area networks (MANS), telecom carrier networks, and enterprise networks.

130: Network edge servers—This includes, but are not limited to, smart routers, network hubs, mobile edge computing (MEC) resources, Wi-Fi routers, micro datacenters, and other compute resources deployed to the network edge.

140: Infrastructure between network edge servers and network edge devices—This includes, but not limited to, wireless cellular network links, Wi-Fi network links, last mile telco network links, cable networks, and satellite radio communications links.

150: Network edge devices—This includes, but is not limited to, IoT devices, cyber-physical systems, industrial machines, handheld devices, cell phones, drones, smart vehicles, robots, and many other types of network edge devices.

160: Network edge sensors and actuators—This includes, but is not limited to, smart sensors, smart actuators, embedded systems, and smart transducers.

### FIG. 2—Grouping Network Fog Nodes Across Problem Spaces

### Description

This drawing shows how network fog nodes can be grouped together, both within and across problem spaces. Example problem spaces might include: smart trucks making routing decisions, smart warehouses which are making decisions about which products to ship and when, and smart retail stores which are making decisions about which products to order. This drawing illustrates how the present invention can make complex decisions across different problem spaces, while running directly on network fog devices. As described throughout this specification, these kinds of optimization problems can be computationally challenging to solve. The present invention puts forth a uniquely innovative way to solve these problems while operating on network fog nodes.

Callouts:

210: Node group within a problem space—The rounded rectangle represents a node group. It encloses several boxes that represent network fog nodes that are all in the same node group. The entire group exists within a shaded box, which represents a single problem space. Thus, this group of nodes all work together within the same problem space. An example might be a group of smart trucks that work together to make routing decisions (a single problem space).

220: Node group that spans problem spaces, Example 1—This dotted line represents a node group that extends across problem spaces. In this example, three nodes in the group lie within one problem space, and a third node in the group lies within a separate problem space. An example might be a single smart truck that makes routing decisions while interacting with three smart warehouses which are making decisions about which products to ship and when.

230: Node group that spans problem spaces, Example 2—This dotted line represents a node group that extends across problem spaces. In this example, two nodes in the group lie within one problem space, and four nodes in the group lie within a separate problem space. An example might be a two smart warehouses which are making decisions about which products to ship and when, while interacting with four smart retail stores which are making decisions about which products to order.

240: Node that is included in multiple node groups—This shows a single network fog node which is included in two different groups. An example might be a smart warehouse that is making decisions about which products to ship and when, while interacting both with a group of smart trucks, and with a group of smart retail stores.

250: Node-internal problems vs. node interaction problems—This shows that some problem variables and data are related only to the internal functions within a network fog node, while other problem variables and data are related to the interactions among network fog nodes.

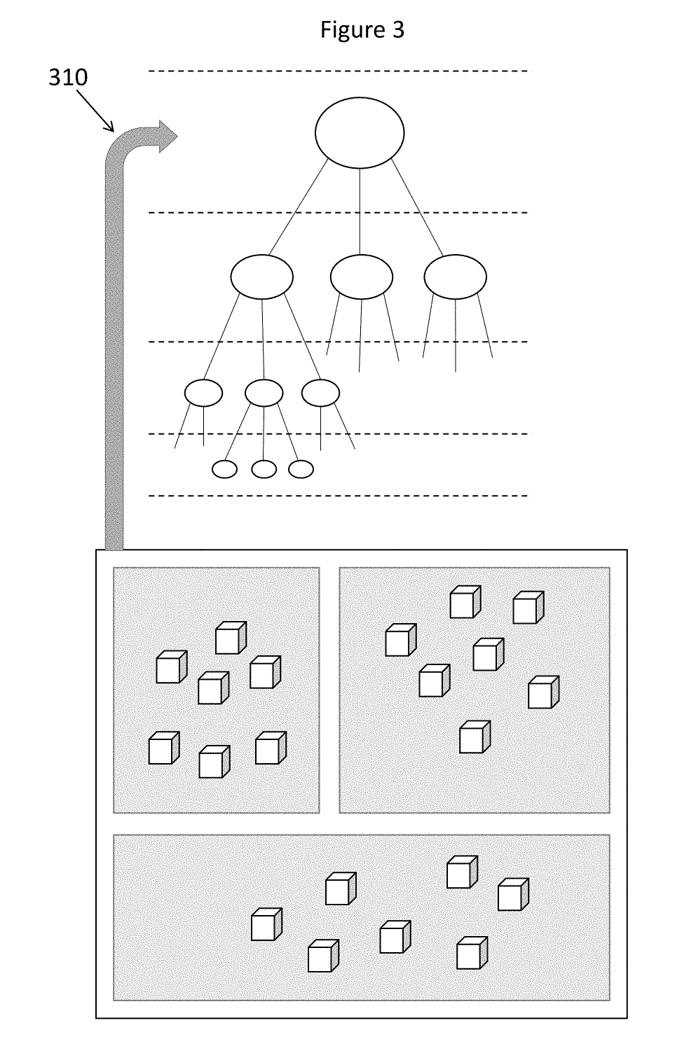

### FIG. 3—Uploading Data to the Network Core

### Description

This drawing shows how data is traditionally uploaded from network edge nodes to the network core, where data analytics services reside. The present invention offers an alternative to this approach.

Callouts:

310: Uploading data from multiple problem spaces to the network core—This shows data that is generated on network edge nodes within multiple problem spaces being uploaded to the network core. This can be an expensive and time consuming process, as the amount of data grows over time.

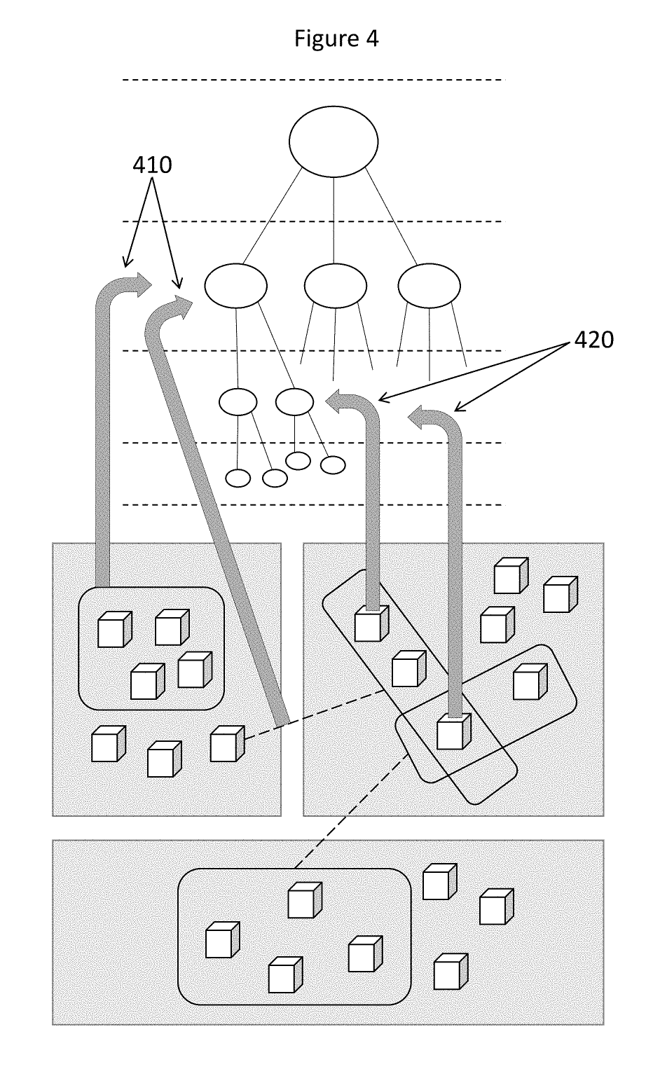

### FIG. 4—Reformulating a Flat Analytical Problem as a Hierarchically Decomposed Mathematical Program

### Description

This drawing shows how a flat analytical problem can be reformulated as a hierarchically decomposed mathematical program. The reduced master problem reflects the decision variables that apply across the network fog nodes within a group. Each subproblem instance is represented on an individual fog node within a group. In order to solve the hierarchical problem representation, the present invention iterates between solving the reduced master problem and solving the subproblems. Each iteration brings the solution closer to optimality.

Callouts:

410: Generating a reduced master problem—This shows how a reduced master problem is generated across a group of network fog nodes which reside at a lower level of the hierarchy. In one example, the reduced master problem is generated out of a group of fog nodes within a single problem space. In the other example, the reduced master problem is generated out of a group of fog nodes that spans across multiple problem spaces.

420: Generating subproblems—This shows how subproblems are generated on individual fog nodes.

### FIG. 5—Mathematical Program Decomposition Block-Angular Structure and Network Fog Nodes

### Description

This drawing illustrates how the block-angular structure of a decomposed mathematical program is used by the present invention to represent the reduced master problem and the subproblems on the individual fog nodes.

The x values across the top show the decision variables. Decision variables represent such decisions as: the time a product will be shipped, the route a truck will take, or the number of units that will be shipped. Decision variables can also represent more abstract notions, such as the slope of a trend line where the problem is to minimize the distances between a set of points and the trend line, by choosing the optimal slope (along with the optimal Y-intercept value). These x values, the decision variables, are the solutions that are sought when the mathematical program is processed by a solver.

The c values on the second line are the “costs” associated with each decision variable. In a mathematical term, this would be expressed as:

c(sub 0)*x(sub 0)+c(sub 1)*x(sub 1)+ . . . +c(sub R)*x(sub R)

The above mathematical term is called the “objective function”. The goal of the mathematical program is to minimize or maximize the objective function. For example, the goal might be to minimize the costs associated with shipping a set of products from certain warehouses using certain trucks. This is accomplished by choosing the best shipping times, routes, number of products shipped, and so forth. The “costs” (the c values) allow the mathematical program to be expressed in a way that captures how much each of the factors cost, in terms of dollars, or time, or any other quantity of interest (including abstract costs, such as the distance of a point from the trend line, in a linear regression problem).

The A1 row contains matrixes that express the constraints of the mathematical program that apply across the fog nodes. The A1 row, thus, expresses the reduced master problem, that the present invention uses this to express the “node-interaction problem”. For example, A1 (sub 1) might express how many units of a product must be received by a certain date. This is a constraint that may apply to more than one of the individual fog nodes, since all fog nodes must complete their part of the process in time for the overall deadline to be met.

Each of the A2 rows contain a single block, which is a matrix of constraints, which the present invention applies to a single fog node (or to a group of fog nodes, as will be shown in FIG. 6). The present invention uses this to express a “node-internal” problem. For example, A2(sub 1) may describe the internal constraints that a specific smart truck must meet in order to successfully deliver a set of products on time. These constraints could include decisions about when to stop for fuel, which roads to avoid due to construction or weather patterns, and so forth. Each A2 row contains a non-intersecting matrix of constraint variables. This is why the A2 rows are called the block-angular structure.

The b values on the right, known as the “right hand side”, are the values that the constraints are applied against. For example, if the sum of a set of costs must be less than or equal to a maximum cost value, the corresponding b value would indicate the maximum cost value.

Callouts:

510: Associating a column block with a network node, Example 1—This arrow shows how the present invention associates a particular block in the block-angular structure of a decomposed mathematical program with a particular network fog node.

520: Network node within a network node group that spans problem spaces—This box represents of network fog node that the present invention associates with a block in the block-angular structure of a decomposed mathematical program.

530: Associating a column block with a network node, Example 2—This arrow shows how the present invention associates a particular block in the block-angular structure of a decomposed mathematical program with a particular network fog node, in this case a network fog node that resides within a group of nodes in the same problem space.

540: A problem space that contains network nodes—This rounded rectangle represents a grouping of network fog nodes, within the same problem space.

### FIG. 6—Hierarchical Mathematical Program Decomposition Block-Angular Structure and Network Fog Nodes

### Description

This drawing is identical to FIG. 5, except the A2(sub R) block in the block-angular structure applies to a group of network fog nodes, rather than a single network fog node. This illustrates how the present invention can be applied hierarchically. The present invention enables a group of network fog nodes to be processed by a lower-level decomposed mathematical program solver. The results can then be passed up a level in the hierarchy, where those results now represent the decision variable values for a single subproblem within a larger decomposed mathematical program.

Callouts:

610: Associating a column block with a network node group—This arrow represents the association between a block in the block-angular structure of a decomposed mathematical program with a group of network fog nodes.

### FIG. 7—Deploying Components to Network Fog Nodes

### Description

This figure shows the process of downloading mathematical programs and solvers to network fog nodes. This is a central feature of the present invention, because it enables the ability to reconfigure mathematical programs in order to address dynamic real-world problems.

Callouts:

710: Component, Example 1—This shows a component which is downloadable to multiple network fog nodes. Most commonly, the component type includes, but is not limited to: 1) mathematical programs, 2) decomposed mathematical programs, 3) mathematical program solvers, and 4) decomposed mathematical program solvers.

720: Component, Example 2—This shows another example of a component which is downloadable to multiple network fog nodes.

730: The process of deploying components to network fog nodes—This arrow illustrates the process of deploying a component to a network fog node. Most commonly, this process includes, but is not limited to, wireless network communications links which transfer the components to the network fog nodes.

740: A network fog node—This box represents a network fog node. This is the target of a deployment operation, and will receive the downloaded components.

### FIG. 8—Network Fog Nodes with or without Built-in Decomposed Mathematical Program Solvers

### Description

This figure shows two possible configurations of network fog nodes. The network fog node on the left contains a downloaded mathematical program which runs on top of a downloaded mathematical program solver. The network fog node on the right contains a downloaded mathematical program which runs on top of a mathematical program solver that is built into the network fog nodes. Other possible configurations are also possible. An important benefit of the present invention is: Since mathematical programs can represent many common data analytical problems (including, but not limited to, regression, clustering, classification, optimization, and other problems), a single mathematical program solver could potentially be built into each network fog node. This would enable the network fog nodes to solve a wide range of analytical problems, without having to use complex and specialized coded algorithms, such as one specially coded algorithm for regression, another specially coded algorithm for clustering, and so forth. This can make it possible to reduce network traffic when updating network fog nodes to solve new kinds of problems, and to more easily maintain the functionality on the network fog nodes.

Callouts:

810: Network fog nodes—The boxes represent two network fog nodes.

820: Downloaded mathematical programs—The cylinders represent downloaded mathematical programs or decomposed mathematical programs.

830: Downloaded mathematical program solver—The cylinder represents a downloaded mathematical program solver or decomposed mathematical program solver.

840: Mathematical program solver that is built into a network fog node—The box represents a mathematical program solver or decomposed mathematical program solver that is built into the network fog node.

### FIG. 9—Basic Information Scheme

### Description

Mathematical program decomposition information schemes provide different ways of coordinating the iterative solver process, between solving the reduced master problem, and solving the subproblems. The output of the reduced master problem is a new set of “prices” that are sent to the subproblems. The subproblems then resolve their mathematical programs and produce a new set of decision variable values, that are returned to the reduced master problem. The reduced master problem then decides which variables (a.k.a. columns in the constraint matrix) will be included in the next round, and then sends to the corresponding “prices” to the subproblems. This iterative process repeats, and comes closer to optimality with each iteration. When the solution has reaches a sufficiently optimal solution (where the required level of optimality is determined by the particular application), the iterative process halts, and the resulting optimized decision variables are then available to the application.

With the Basic Information Scheme, the subprograms generate proposed decision variable values, while the reduced master program solver remains idle and waits for all of the proposals to come in. The process of determining new prices begins after all of the subproblem solvers have submitted their proposals. During the time when the reduced master problem solver is processing the proposals, subprogram solvers can only remain idle and wait for the new prices to start another round of proposals generation.

The BIS information scheme is the most common approach among solvers for decomposed mathematical programs. However, in the context of the present invention, the BIS information scheme is unlikely to be the best approach. One reason for this is that network connections to the fog nodes can be unreliable or intermittent. Waiting for results from all subproblem solvers can dramatically increase the time required to find a solution. Thus, the present invention includes other information schemes which make the application of mathematical program decomposition to the context of distributed processing on network fog nodes much more practical and efficient.

Callouts:

910: Execution timeline for reduced master problem solver—This row shows the times when the reduced master problem solver is active.

920, 930, 940: Execution timelines for subproblem solvers—These rows show the times when the subproblem solvers are active.

950, 960: Reduced master problem solver cycle completion times—These points in time indicate when each cycle completes. This occurs when the reduced master problem solver finishes determining the next set of prices, and sends those prices to the subproblem solvers on the network fog nodes.

970: Cycle length for iteration between the reduced master problem and the subproblems—This indicates the time that it takes to complete each cycle. Generally, shorter cycle times are desired. But the real measure of success is the overall time that is required to reach an optimal solution. In the case of the present invention, the number of iterations, and the amount of data passed back on forth during each iteration, are also important, because the present invention seeks to minimize network traffic.

980: Direction of time—This arrow indicates the direction of the flow of time.

### FIG. 10—Early Start Information Scheme

### Description

With the Early Start Information Scheme (ESIS), the reduced master program solver begins to generate the next set of columns and corresponding prices before all of the subprograms have returned their decision variable values. Eventually, all of the same proposals from the subproblems will be received, as in BIS (above). But, the ESIS approach may result is faster iteration cycles, since the reduced master problem solver can begin working earlier in the cycle. For the present invention, this can be helpful in scenarios where the subproblem solvers on the network fog nodes return their decision variable values at different rates. This could be due to a number of situations. For example, the data set sizes may be vary across the network fog nodes, requiring some subproblem solvers to process more data on each iteration. As another example, the network connection for some network fog nodes may be slower or more intermittent than for other network fog nodes.

Callouts:

1010: Execution timeline for the reduced master problem solver—This row shows the times when the reduced master problem solver is active.

1020, 1030, 1040: Execution timelines for subproblem solvers—These rows show the times when the subproblem solvers are active.

1050, 1060, 1070: Reduced master problem solver cycle completion times—These points in time indicate when each cycle completes. This occurs when the reduced master problem solver finishes determining the next set of prices, and sends those prices to the subproblem solvers on the network fog nodes.

1080: Cycle length for iteration between reduced master problem and subproblems—This indicates the time that it takes to complete each cycle.

1090: Direction of time—This arrow indicates the direction of the flow of time.

### FIG. 11—Early Termination Information Scheme

### Description

With the Early Termination Information Scheme (ETIS), the reduced master program solver instructs the subproblem solvers on the network fog nodes to stop processing after some number of subproblems have returned their decision variable values. The reduced aster problem then produces the next set of columns and corresponding prices based on the input that has already been received. Thus, with ETIS, fewer proposals from the subproblems may be received, relative to BIS and ESIS (above). The ETIS approach will typically result is faster iteration cycles, but may require more iterations in order to reach a given level of optimality, since fewer subproblem proposals are processed during each cycle. For the present invention, ETIS may work very well in cases where experience has shown that only a certain number of subproblem decision variable values typically need to be received in order to obtain overall results at the desired level of optimality, within an acceptable timeframe. In fact, given that many IoT applications will solve the same problems repeatedly, but with dynamically varying data sets, it is likely that ETIS can produce results at an acceptable level of optimality more quickly than BIS or ESIS. This is especially true given that IoT network connections can be intermittent or unreliable, and it may not make sense to wait for all subproblem results to be returned.

Callouts:

1110: Execution timeline for the reduced master problem solver—This row shows the times when the reduced master problem solver is active.

1120, 1130, 1140: Execution timelines for subproblem solvers—These rows show the times when the subproblem solvers are active.

1150, 1160, 1170: Reduced master problem solver cycle completion times—These points in time indicate when each cycle completes. This occurs when the reduced master problem solver finishes determining the next set of prices, and sends those prices to the subproblem solvers on the network fog nodes.

1180: Cycle length for iteration between reduced master problem and subproblems—This indicates the time that it takes to complete each cycle.

1190: Direction of time—This arrow indicates the direction of the flow of time.

### FIG. 12—Intermediate Prices Information Scheme

### Description

With the Intermediate Prices Information Scheme (IPIS), the reduced master program solver provides prices to the subproblems while the subproblems are still in the process of generating proposals. These are referred to as “intermediate prices”. Intermediate prices determined by the reduced master program solver can be fed back to the subproblem solvers at different rates, and this can be determined by the particular application requirements. With the present invention, this approach tends to increase network traffic, but it also speeds up feedback between the reduced master problem solver and the subproblem solvers. Thus, applications where network traffic must be reduced as much as possible may not choose this approach. However, applications where very fast feedback between the reduced master problem solver and the subproblem solvers is required, may find IPIS to be an attractive way to optimize the performance of the present invention. Thus, through the use of information schemes, the present invention provides a level of flexibility and performance tuning that make it easily adaptable to a wide variety of real-world applications and scenarios.

Callouts:

1210: Execution timeline for the reduced master problem solver—This row shows the times when the reduced master problem solver is active.

1220, 1230, 1240: Execution timelines for subproblem solvers—These rows show the times when the subproblem solvers are active.

1250, 1251, 1252, 1253, 1254, 1255, 1256: Reduced master problem solver cycle begin times—These points in time indicate when each cycle begins. This occurs when the reduced master problem solver begins determining the next set of prices.

1260: Direction of time—This arrow indicates the direction of the flow of time.

### FIG. 13—Dynamic Reconfiguration Facility

### Description

The dynamic reconfiguration facility is described in “(8) DYNAMIC RECONFIGURATION FACILITY”. FIG. 13 illustrates how dynamic reconfiguration works. Dynamic reconfiguration enables network fog nodes to be added and removed, to and from the reduced master problems, and to and from the subproblems, which are associated with decomposed mathematical programs. For example, callout 1310 shows a network fog node that is added to a subproblem, and callout 1330 shows a network fog node that is removed from a subproblem.

Callouts:

1310: A network fog node that is added to a subproblem—Although the drawing shows a single network fog node being added to a single subproblem, there are a number of other use cases, including but not limited to: 1) more than one node at a time involved in the dynamic reconfiguration process; 2) adding and removing network fog nodes to and from reduced master problems; 3) adding and removing nodes to and from multiple problems (subproblems and/or reduced master problems).

1320: The process of adding a network fog node to a subproblem—In order to accomplish this, two things must occur: 1) the internal columns associated with the network fog node (the node-internal problem) are added to the subproblem which, in the case of callout 1320, are the columns in the A2(sub 1) matrix; and 2) the external columns associated with the network fog node (the node-interaction problem) are added to the reduced master problem which, in the case of callout 1320, are the columns in the A1(sub 1) matrix.

1330: A network fog node that is removed from a subproblem—Although the drawing shows a single network fog node being removed from a group of nodes that make up a single subproblem, there are a number of other possibilities, as described in “(8) DYNAMIC RECONFIGURATION FACILITY”.

1340: The process of removing a network fog node from a subproblem—In order to accomplish this, two things must occur: 1) the internal columns associated with the network fog node (the node-internal problem) are removed from the subproblem which, in the case of callout 1340, are the columns in the A2(sub R) matrix; and 2) the external columns associated with the network fog node (the node-interaction problem) are removed from the reduced master problem which, in the case of callout 1340, are the columns in the A1(sub R) matrix.

### FIG. 14—Subproblem Roaming Facility

### Description

Subproblem roaming is a specialized form of dynamic reconfiguration, where network fog nodes are, in the most common use case, removed from one subproblem and added to another subproblem.

It is convenient to speak of this facility as subproblem roaming, because most commonly it involves roaming of network fog nodes from one subproblem to another. However, this should not be construed to limit subproblem roaming to that one particular use case. Rather, subproblem roaming can involve many more generalized use cases, including but not limited to: 1) more than one node at a time involved in the roaming process; 2) roaming of network fog nodes between reduced master problems; 3) roaming of network fog nodes from subproblems to reduced master problems, and roaming of network fog nodes from reduced master problems to subproblems; 4) roaming of network fog nodes from multiple source problems (subproblems and/or reduced master problems); 5) roaming of network fog nodes to multiple destination problem (subproblems and/or reduced master problems).

Callouts:

1410: A network fog node that will roam from one subproblem to another—Although the drawing shows a single network fog node that will roam from one subproblem to another, there are a number of other possibilities, as described in “(8) DYNAMIC RECONFIGURATION FACILITY”.

1420: The process of roaming from one subproblem to another—In order to accomplish this, two things must occur: 1) the internal columns associated with the network fog node (the node-internal problem) are removed from the source subproblem, A2(sub R) and added to the destination subproblem, A2(sub 1); and 2) the external columns associated with the network fog node (the node-interaction problem) are removed from the source columns of the reduced master problem, A1(sub R) and added to the destination columns of the reduced master problem, A1(sub 1).

1430: A network fog node that has roamed from one subproblem to another—Although the drawing shows a single network fog node that will roam from one subproblem to another, there are a number of other possibilities, as described in “(8) DYNAMIC RECONFIGURATION FACILITY”.

### FIG. 15—Process Flow for Dynamic Reconfiguration and Subproblem Roaming

### Description

This drawing shows the main information processing steps that are typically required to implement the dynamic reconfiguration process and the subproblem roaming process. These specific steps serve to convey the basic process by way of illustration only, and so that this disclosure will be thorough, complete, and will fully convey the full scope of the invention to those skilled in the art. However, the specific steps used in an implementation of the present invention may be different, and this drawing should not be construed as limiting the process to the steps described herein.

Callouts:

1510: Evaluate state based on dynamic reconfiguration model—The current state is defined by the values of variables that may include, but are not limited to: 1) the status of the network fog nodes (such as online/offline, lower power mode, network connection status, and so forth); 2) the status of the optimization problems that are currently being solved (such as in-process, stalled, terminated, successfully completed); 3) the state of the data streams that are being received on the network fog nodes (such as overloaded by large quantities of data, normal data value ranges are being received, an outlier occurred); 4) and many other possible state variable values. The state is processed against the dynamic reconfiguration model, which is an analytical model that typically has been developed through machine learning based on past experience. For example, a dynamic reconfiguration model might discover that when food products are being delivered by drones to a certain zip code area, that the number of drones is currently inadequate. Note that these variables would typically be specified by a set of columns in a decomposed mathematical program, which represent a constraint, which specifies that a minimum amount of drone carriage capacity must be available. The dynamic reconfiguration component would then add a drone subproblem, where that drone subproblem contains columns that indicate the required amount of available carriage capacity as well as a history of delivering products within the given zip code area.

1520: Select fog node(s) to reconfigure or roam—This is the process of selecting the network fog nodes that will be added/removed to and from specific subproblems. Continuing with the drone example, this process would select the drone subproblems that are to be added/removed to and from the relevant reduced master problem, and these subproblems might represent drones that are available to be assigned to specific food delivery tasks.

1530: Solve optimization problem—This is the process of actually running the solvers for the decomposed mathematical programs. It involves using the newly added and removed subproblems, in the steps above. Continuing with the drone example, this process would actually assign specific drones to specific food delivery tasks.

1540: Evaluate solving process via inward facing optimization—This is the process of evaluating the level of the success of the solution that was chosen for the decomposed mathematical program. Continuing with the drone example, this process would determine how successful the chosen drone allocation scheme was, for example with respect to achieving on time delivery with minimal drone fuel consumption. This process utilizes the present invention's “inward facing optimization” capability. Essentially, this is the same process that is used by the present invention to solve optimization problems in general, but it is used to assess the quality of the decisions made by the present invention, itself. Continuing with the drone example, this process might compare the drone delivery times (which are state variables) to the past experiences of all the drones in the fleet, and determine whether the results were better than or worse than what might have been achieved if other drones had been selected under the prevailing conditions. This would typically be represented as an optimization problem that is decomposed and solved across the entire set of drones.

1550: Update dynamic reconfiguration model—This is the process of updating the dynamic reconfiguration model, based on the new latest results that were received from the previous step. Continuing with the drone example, this process would update the model, perhaps adding greater weight to the solution that was chosen (if it was relatively successful) or reducing the weight of the selected solution (if it was relatively unsuccessful). These weights would typically be represented as “prices” in the decomposed mathematical program columns.

1560: State changes—This represents a change in the state of the environment, which is typically beyond the control of the application. It results in the need to repeat the dynamic reconfiguration or subproblem roaming process. Continuing with the drone example, a state change might be where the number of available drones changes, or the quantity of food delivery orders changes, or the zip code where the orders are occurring changes. By repeating the process, different combinations of drones might be assigned to different aspects of the drone delivery process.

By continually repeating the dynamic reconfiguration or subproblem roaming processes, and by continually refining the process via the inward facing optimization process, the present invention can provide an “intelligent swarming” capability. For example, if the drone delivery problem utilized large numbers of drones, and involved a complex set of drone delivery tasks, the drones could “swarm” intelligently and in a coordinated fashion, in order to solve a variety of dynamically evolving tasks.

### (15) Definitions of Terms

Benders decomposition—A method of solving decomposed mathematical programs by using row generation. The present specification emphasizes Dantzig-Wolfe decomposition, which uses column generation. But, Benders decomposition is mathematically equivalent to Dantzig-Wolfe decomposition. See Lim (2011) [12].

Dantzig-Wolfe decomposition—A particular form of mathematical program decomposition developed by George Dantzig and Philip Wolfe. Dantzig-Wolfe decomposition relies on delayed column generation for improving the tractability of large-scale linear programs.

Dantzig-Wolfe decomposition information schemes—A method for improving Dantzig-Wolfe decomposition performance, proposed by Ho and Lee [13]. For more information, see “(9) Tuning solvers for efficient solution convergence”, contained herein.

Dantzig-Wolfe decomposition solver—Computer processing instructions which solve decomposed mathematical programs by using the Dantzig-Wolfe decomposition method. In the present invention, a specific Dantzig-Wolfe decomposition solver may solve 1) the reduced master problem, 2) the subproblems, or 3) both the reduced master problem and the subproblems.

Data analytics—The process of analyzing data in order to discover patterns, meaning, or other value in the data.

Data transport component—Computer processing instructions which transport data from its current location to other locations, most commonly by utilizing some type of digital network. For example, a data transport component on a network server might send data to network clients.

Decision variable—A variable within a mathematical program that can be controlled, i.e. is not random. Running a mathematical program produces values for the decision variables, which are intended to be the optimal values for those decision variables. Examples of decision variables include, but are not limited to: the decision about whether to vaccinate a population (true or false); the decision about the amount of budget to spend (a continuous variable between some minimum and maximum), the decision about how many cars to allocate to a car pool (a discrete variable between some minimum and maximum).

Decomposed mathematical program—A mathematical program that has been reformulated as a reduced master problem and one or more subproblems, by using a technique such as Dantzig-Wolfe decomposition.

Decomposed mathematical program solver—Also called a “solver for decomposed mathematical programs”. Computer processing instructions which solve decomposed mathematical programs. In the context of the present invention, a decomposed mathematical program solver may solve 1) the reduced master problem, 2) the subproblem, or 3) both the reduced master problem and the subproblem.

Dynamic reconfiguration component—Computer processing instructions which dynamically configure the processing of the present architecture. For example, a dynamic reconfiguration component might cause groups of network fog nodes to be dynamically created and modified, so that these groups can come together to solve a problem, and then be dynamically reassembled in different configurations in order to solve other problems. A dynamic reconfiguration component may optionally use inward facing optimization to automatically learn from past experience. For more information see “(8) DYNAMIC RECONFIGURATION FACILITY”. Also see FIG. 13, “DYNAMIC RECONFIGURATION FACILITY”, and FIG. 15, “PROCESS FLOW FOR DYNAMIC RECONFIGURATION AND SUBPROBLEM ROAMING”, and their descriptions in (14) DETAILED DESCRIPTION OF THE DRAWINGS.

Dynamic reconfiguration facility—The capability of the dynamic reconfiguration component.

Edge analytics—The process of performing data analytics functions by running computer processing instructions on network edge nodes. Some aspects of an edge analytics solution may run computer processing instructions on network core nodes.

Functional groups—Groups of network fog nodes that work together to perform functions, such as data analytics functions. The capabilities of functional groups include the networking facilities that enable the network fog nodes to communicate and to exchange data.

Information schemes—See “Mathematical program decomposition information schemes”.

Independent mathematical programs—Two or more mathematical programs that can be solved independently of each other. Thus, the solution to an independent mathematical program does not depend on the solution to any of the other mathematical programs.

Intermediary results—A used herein, intermediary results refer to: 1) the output of a reduced master problem solver, which may serve as input to subproblem solvers; or 2) the output of a subproblem solver, which may serve as input to a reduced master problem solver.

Inward facing optimization—The ability of the dynamic reconfiguration facility to utilize the present invention's internal resources and methods to improve it's own functioning, and to potentially do this in the background continuously, which has the potential to continually improve the performance of the present invention and the quality of the analytical results produced by the present invention. For more information, see “(7) DYNAMIC RECONFIGURATION FACILITY”.

Lagrangian Relaxation—A method of solving a mathematical program by relaxing the constraints, and essentially solving a simpler mathematical program than the original. Lagrangian Relaxation is mathematically equivalent to Dantzig-Wolfe decomposition. See Lim (2011) [12], and Lemar'echal (2003) [19].

Mathematical program—A specification of an optimization problem that is to be solved. Examples include, but are not limited to: linear programs, mixed integer linear programs, non-linear programs, and mixed integer non-linear programs.

Mathematical program decomposition information schemes—Also called “information schemes for decomposed mathematical programs”. A method for improving the performance of decomposed mathematical program solvers, that is generalized from Dantzig-Wolfe decomposition information schemes, proposed by Ho and Lee [13]. Mathematical program decomposition information schemes can be applied to any method of solving a decomposed mathematical program which iterates between solving a reduced master problem and solving subproblems, including column generation methods and row generation methods.

Mathematical program decomposition—The process of reformulating a mathematical program as a reduced master problem and one or more subproblems.

Mathematical program solver—Computer processing instructions which solve mathematical programs.

Mathematical program solver process—A process which solves mathematical programs.

Multi-tier hierarchical decomposition structures—The structure of an optimization problem where a set of reduced master problems at one level of the hierarchy serve as the subproblems for a reduced master problem at the next higher level of the hierarchy.

Network core node—A computational resource that is deployed at the core of a network. Network core nodes include, but are not limited to: enterprise servers, high-performance computing (HPC) clusters, and elastic cloud services. A network core node may also consist of related facilities or services, including but not limited to: storage facilities, networking services, and application services. In FIG. 1, “OPERATIONAL CONTEXT FOR THE PRESENT INVENTION”, network core nodes include any nodes deployed to the layer designated by callout 110.

Network edge node—A computational resource that is deployed at the edge of a network. Network edge nodes include, but are not limited to: wireless devices, cyber-physical systems, network hubs, smart routers, network edge servers, and micro datacenters. A network edge node may also consist of related facilities or services, including but not limited to: storage facilities, networking services, and application services. In FIG. 1, “OPERATIONAL CONTEXT FOR THE PRESENT INVENTION”, network edge nodes include any nodes deployed to the layers designated by callouts 130, 150, and 160.

Network fog nodes—Computational resources that necessarily include network edge nodes, but may optionally include network core nodes. In some instances, for the sake of brevity, this specification refers to “network fog nodes”. In other instances, for the sake of clarity in a particular context, this specification uses more verbose phrases such as “network edge nodes and optionally network core nodes”.

Optimization problem—An analytical problem that accepts input which may include, but is not limited to: 1) data; and 2) a definition of a problem related to that data, for which an optimal solution is to be found. An example of an optimization problem is a linear program, which typically consists of an objective function, and a set of constraints, and possibly other elements, and which may be applied against a data set. A typical optimization problem example would be to maximize the number of units shipped from a factory, while minimizing the associated costs. However, it should be noted that many types of data analytics problems can be expressed as optimization problems, beyond the sorts of problems that would intuitively be classified as optimization problems, and these include but are not limited to: regression, clustering, classification, Bayesian analysis, and other types of analytical problems.

Overall problem—This specification uses the term “overall problem” to refer to the original optimization problem that exists on and across a set of network fog nodes, and which can be reformulated as a decomposed mathematical program, and which would therefore be expressed as a “reduced master problem” and a set of “subproblems”. In the published literature, this concept would typically be called the “master problem” (although it would have no relationship to network fog nodes). The term “overall problem” is used in this specification in order to avoid confusion between the terms “master problem” and “reduced master problem”.

Presolver component—Computer processing instructions which present a mathematical program to a mathematical program solver in a properly formulated form, in order to optimize the performance of the mathematical program solver. There are certain rules a properly formulated mathematical program must satisfy. It should contain as few variables, constraints and non-zeros in the definition of the mathematical program as possible. It must be well-scaled and the constraints within the mathematical program specification must be independent. A presolver component improves the performance of a mathematical program solver by assuring that the input mathematical program adheres to these criteria. Presolve techniques are described in [10].

Problem space—An optimization problem area that is relatively narrow in scope and relatively consistent in nature. For more information, see “(2) CAPABILITY TO WORK ACROSS PROBLEM SPACES WHILE OPERATING AT THE NETWORK EDGE”, contained herein.

Reduced master problem—Part of a decomposed mathematical program. When a mathematical program is decomposed, it is reformulated as a reduced master problem and one or more subproblems. For more information, see “(6) EDGE ANALYTICS AND MATHEMATICAL PROGRAM DECOMPOSITION”.

Reduced master problem solver—Also called a “solver for a reduced master problem”. Computer processing instructions which solve a reduced master problem, as part of the process of solving a decomposed mathematical program.

Solver—An information processing component that solves analytical problems. One type of solver is a decomposed mathematical program solver.

Solver for decomposed mathematical programs—See Decomposed mathematical program solver.

Subproblem—Part of a decomposed mathematical program. When a mathematical program is decomposed, it is reformulated as a reduced master problem and one or more subproblems. For more information, see “(6) EDGE ANALYTICS AND MATHEMATICAL PROGRAM DECOMPOSITION”, contained herein.

Subproblem roaming—Subproblem roaming is a unique innovation set forth herein, where a network edge node, which might be a mobile network edge node such as a smart truck, can move from one decomposed mathematical program subproblem group to another. For more information, see “(10) SUBPROBLEM ROAMING”, contained herein, and FIG. 14 “SUBPROBLEM ROAMING”, and FIG. 15 “PROCESS FLOW FOR DYNAMIC RECONFIGURATION AND SUBPROBLEM ROAMING”.

Subproblem solver—Also called a “solver for subproblems”. Computer processing instructions which solve subproblems for decomposed mathematical programs. A subproblem solver participates in an iterative process that also involves a reduced master problem solver.

Warm start component—Computer processing instructions which enable mathematical program solvers to produce results more quickly by utilizing knowledge from past experience about similar input mathematical programs and input data. By providing warm start information to mathematical program solvers, warm start components enable the mathematical program solvers to begin processing at a point that is already close to the optimal solution, and thereby reduce the computational effort required to reach an optimal solution.

### (16) References

[1] George B. Dantzig; Philip Wolfe (1960). “Decomposition Principle for Linear Programs”. Operations Research 8: 101-111.
[2] George B. Dantzig (1963). “Linear Programming and Extension”. A Report Prepared for United States Airforce Project RAND.
[3] James K. Ho (1986). “Recent Advances in the Decomposition Approach to Linear Programming”. Management Science Program, College of Business Administration, University of Tennessee.
[4] J. K. Ho; R. P. Sundarraj (1989). “DECOMP: an Implementation of Dantzig-Wolfe Decomposition for Linear Programming”. Lecture Notes in Economics and Mathematical Systems, Springer Science+Business Media, LLC.
[5] James Richard Tebboth (2001). “A Computational Study of Dantzig-Wolfe Decomposition”. Thesis submitted for the degree of Doctor of Philosophy in the University of Buckingham.
[6] Shohei Hido; Seiya Tokui; Satoshi Oda; (2013). “Jubatus: An Open Source Platform for Distributed Online Machine Learning”. Big Learning Advances in Algorithms and Data Management.
[7] Sean Gilpin; Siegfried Nijssen; Ian Davidson; (2013). “Formalizing Hierarchical Clustering as Integer Linear Programming”. Proceedings of the Twenty-Seventh AAAI Conference on Artificial Intelligence.
[8] IEEE/ACM Symposium on Edge Computing; http://conferences.computer.org/sec/index.html
[9] OpenFog Consortium; http://www.openfogconsortium.org/[10]
[10] Erling D. Andersen; Knud D. Andersen; (1993). “Presolving in linear programming”. Mathematical Programming 71 (1995) 221-245.
[11] Williams, H. Paul (2013-01-18). Model Building in Mathematical Programming (Kindle Locations 1785-1787). Wiley. Kindle Edition.
[12] Churlzu Lim; (15 Feb. 2011). “Relationship among Benders, Dantzig-Wolfe, and Lagrangian Optimization”. Wiley Encyclopedia of Operations Research and Management Science.
[13] James K. Ho; Tak C. Lee; (March, 1989). “Dynamics of Information in Distributed Decision Systems”. Publisher: PN (1989), ASIN: BOODD79KDK.
[14] L. E. Sokoler et al; (Jan. 10, 2014). “A Dantzig-Wolfe Decomposition Algorithm for Linear Economic Model Predictive Control of Dynamically Decoupled Subsystems”. (http://people.compute.dtu.dk/jbjo/publications/DTU_MPC_2014_14/SubmittedManusc ript.pdf) Department of Applied Mathematics and Computer Science, Technical University of Denmark, DK-2800 Kgs. Lyngby, Denmark.
[15] Ocaña et al; (October 2016). “Decentralized Coordination of a Building Manager and an Electric Vehicle Aggregator”. IEEE Transactions on Smart Grid PP(99) (https://www.researchgate.net/publication/309081302_Decentralized_Coordination_of_a_Building_Manager_and_an_Electric_Vehicle_Aggregator).
[16] Yang et al; (October 2015). “Joint scheduling of large-scale appliances and batteries via distributed mixed optimization”. Power & Energy Society General Meeting, 2015 IEEE.
[17] Altay et al; (October 2014); “Distributed energy management of microgrids with Dantzig-Wolfe decomposition”. Innovative Smart Grid Technologies Conference Europe (ISGT-Europe), 2014 IEEE PES.
[18] Y. Sekine; (1963) “Decentralized Optimization of an Interconnected System”. IEEE Transactions on Circuit Theory (Volume: 10, Issue: 2)
[19] C. Lemar'echal; (2003); “The omnipresence of Lagrange”. 4OR, 1(1):725.

What is claimed is:

1. An information processing architecture that enables data analytics operations to be performed, comprising:
a) one or more solvers
i. which solve decomposed mathematical programs by using Dantzig-Wolfe decomposition or by using any other analytical method that is mathematically equivalent to Dantzig-Wolfe decomposition, and
ii. which solve decomposed mathematical program subproblems by operating on network edge nodes, and
iii. which solve decomposed mathematical program reduced master problems by operating on network edge nodes or by operating on network core nodes; and
b) one or more dynamic reconfiguration components
i. which dynamically assign said solvers to functional groups, and
ii. which dynamically assign specific decomposed mathematical programs to said solvers within said functional groups,
whereby said solvers within said functional groups collectively solve said specific decomposed mathematical programs.

2. The information processing architecture of claim 1, in which said dynamic reconfiguration components use inward facing optimization to automatically improve the functioning of said dynamic reconfiguration components.

3. The information processing architecture of claim 1, in which one or more subproblem roaming components are used to extend the functionality of said dynamic reconfiguration components.

4. The information processing architecture of claim 1, in which mathematical program decomposition information schemes are used to improve the performance of said solvers.

5. The information processing architecture of claim 2, in which one or more subproblem roaming components are used to extend the functionality of said dynamic reconfiguration components.

6. The information processing architecture of claim 2, in which mathematical program decomposition information schemes are used to improve the performance of said solvers.

7. The information processing architecture of claim 1, in which said solvers are Dantzig-Wolfe decomposition solvers.

8. The information processing architecture of claim 7, in which said dynamic reconfiguration components use inward facing optimization to automatically improve the functioning of said dynamic reconfiguration components.

9. The information processing architecture of claim 7, in which one or more subproblem roaming components are used to extend the functionality of said dynamic reconfiguration components.

10. The information processing architecture of claim 7, in which mathematical program decomposition information schemes are used to improve the performance of said Dantzig-Wolfe decomposition solvers.

11. The information processing architecture of claim 8, in which one or more subproblem roaming components are used to extend the functionality of said dynamic reconfiguration components.

12. The information processing architecture of claim 8, in which mathematical program decomposition information schemes are used to improve the performance of said Dantzig-Wolfe decomposition solvers.

13. The information processing architecture of claim 1, in which said solvers are benders decomposition solvers or Lagrangian relaxation decomposition solvers.

14. The information processing architecture of claim 13, in which said dynamic reconfiguration components use inward facing optimization to automatically improve the functioning of said dynamic reconfiguration components.

15. The information processing architecture of claim 13, in which one or more subproblem roaming components are used to extend the functionality of said dynamic reconfiguration components.

16. The information processing architecture of claim 13, in which mathematical program decomposition information schemes are used to improve the performance of said benders decomposition solvers or said Lagrangian relaxation decomposition solvers.

17. The information processing architecture of claim 14, in which one or more subproblem roaming components are used to extend the functionality of said dynamic reconfiguration components.

18. The information processing architecture of claim 14, in which mathematical program decomposition information schemes are used to improve the performance of said benders decomposition solvers or said Lagrangian relaxation decomposition solvers.
